(19) United States
(12) Patent Application Publication
(10) Pub. No.: US 2026/0323287 A1
(43) Pub. Date: Oct. 15, 2026

(54) System and Method for Deterring Fraud in Online Interactions and Phone Calls

(71) Applicant: Lion Mountain Analytics, LLC, Ridgefield, CT (US)

(72) Inventors: Todd Christian Lowenberg, Brewster, NY (US); Celia Black Lowenberg, Brewster, NY (US)

(73) Assignee: Lion Mountain Analytics, LLC, Ridgefield, CT (US)

(21) Appl. No.: 19/467,407

(22) Filed: Feb. 2, 2026

Related U.S. Application Data
(60) Provisional application No. 63/781,499, filed on Apr. 1, 2025.
(60) Provisional application No. 63/843,713, filed on Jul. 14, 2025.

(51) Int. Cl. H04W 12/06; H04W 12/08

(52) U.S. Cl. CPC H04W 12/068; H04W 12/08

(57) ABSTRACT

The invention provides a computer-implemented platform that improves network and device security by (i) enforcing identity-as-collateral staking before a communication is enabled, (ii) generating per-party distinct session tokens that are linked in the backend to a non-public association token, (iii) maintaining tamper-evident audit and retention controls with dual-domain decryption for subpoenaed releases, and (iv) authenticating and governing artificial-intelligence (AI) agents through capability/delegation certificates with real-time behavior monitoring and revocation. These features yield improved security posture, reduced spoofing and social-engineering risk, and verifiable accountability across voice, video, messaging, email, social media, and remote support channels.

### CROSS-REFERENCE TO RELATED APPLICATIONS

This application claims the benefit of U.S. Provisional Patent Application Ser. No. 63/781,499, entitled System and Method for Deterring Fraud in Online Transactions and Phone Calls, filed on Apr. 1, 2025, and U.S. Provisional Patent Application Ser. No. 63/843,713, entitled System and Method for Deterring Fraud in Online Transactions and Phone Calls, filed on Jul. 14, 2025, the contents all of which are incorporated herein by reference in their entirety for all purposes.

### BACKGROUND

### Technical Field

This invention relates to web-enabled transactions, and more particularly to a system and method that uses digital identity as collateral to deter fraud in human, business, and AI interactions.

### Background Information

Throughout this application, various publications, patents and published patent applications are referred to by an identifying citation. The disclosures of the publications, patents and published patent applications referenced in this application are hereby incorporated by reference into the present disclosure.

Fraud is growing exponentially across human touchpoints. Technical innovation continues to enhance the reach and effectiveness of criminals. There has been little progress in reducing this upward trend. Financial services have been hard hit, e.g., by credit card fraud, identity theft, account takeover, etc. Users of social media contend with cyberbullying, social engineering, online grooming and predation, catfishing, hate crimes, swatting, and incitement to violence. Ecommerce suffers from identity theft, refund and chargeback fraud, counterfeit products, drop ship fraud, and email users contend with phishing, identity theft, ransomware, and malware. The emergence of artificial Intelligence and AI bots/agents has increased opportunities for fraudulent behavior, including deep fakes, synthetic IDs, impersonation/identity cloning, and injection attacks. The emergence of Web3, de-fi, digital currencies, and other tokenized asset technology along with AI agents and their inclusion in mainstream financial services offerings will further expand the opportunities for fraud and the impact of tech-centric criminal activity in the future.

Thus, a need exists for a system and method that addresses the aforementioned issues.

### SUMMARY OF THE INVENTION

The invention provides a computer-implemented platform that improves network and device security by (i) enforcing identity-as-collateral staking before a communication is enabled, (ii) generating per-party distinct session tokens that are linked in the backend to a non-public association token, (iii) maintaining tamper-evident audit and retention controls with dual-domain decryption for subpoenaed releases, and (iv) authenticating and governing artificial-intelligence (AI) agents through capability/delegation certificates with real-time behavior monitoring and revocation. The appended claims may also serve as a summary of the invention.

The claims recite concrete improvements to computer and network functionality. The claimed subject matter is recited as specific technological components-encrypted per-record storage using DEKs/KEKs, deterministic token derivations bound to device identifiers, GUI gating of transport session controls, and certificate-based authorization with online status and revocation. Each claim integrates data handling into a practical application that changes the operation of network communications and user interfaces by technically gating session establishment, preventing cross-party token correlation, and enabling auditable, dual-controlled decryption rather than merely reporting results. The specific combination of record-level encryption and dual-domain release, per-party tokenization linked by a non-public association token, GUI gating tied to staking state, and AI-agent delegated-task enforcement and real-time behavioral monitoring amounts to significantly more than any alleged exception. These features yield improved security posture, reduced spoofing and social-engineering risk, and verifiable accountability across voice, video, messaging, email, social media, and remote support channels.

The features and advantages described herein are not all-inclusive and, in particular, many additional features and advantages will be apparent to one of ordinary skill in the art in view of the drawings, specification, and claims. Moreover, it should be noted that the language used in the specification has been principally selected for readability and instructional purposes, and not to limit the scope of the inventive subject matter.

### BRIEF DESCRIPTION OF DRAWINGS

The present invention is illustrated by way of example and not limitation in the figures of the accompanying drawings, in which like references indicate similar elements and in which:

FIG. 1 is a diagram showing an example process for registering a human user, verifying identity, receiving certified personal data, and completing an underwriting step.

FIG. 2 is a diagram showing an example customer-service phone call in which both participants verify their identities and have those identities recorded as collateral.

FIG. 3 is a diagram showing use of the system within a social-media platform to accept a follow request only after both users verify their identities.

FIG. 4 is a diagram showing an interface identifying a user who has put their identity up as collateral.

FIG. 5 is a diagram showing an example smart-contract process between a service provider and a customer using identity verification.

FIG. 6 is a diagram showing an example emergency-services call in which both parties verify their identities and the interaction is logged.

FIG. 7 is a diagram showing an example process for registering an AI agent with the system and issuing a system certificate.

FIG. 8 is a diagram showing an interaction among a human user and multiple AI agents, each verified by the system, with behavior-monitoring of the AI agents.

FIG. 9 is an example user-interface screen showing an incoming call requiring biometric verification and allowing the recipient to request identity verification from the caller.

FIG. 10 is an example user-interface screen showing an incoming call from a caller who has not verified their identity.

FIG. 11 is an example user-interface screen showing options for handling a call when the caller declines to verify their identity.

FIG. 12 is an example user-interface screen showing an incoming call from a caller who has verified their identity after being prompted.

FIG. 13 is an example user-interface screen showing an incoming call from a verified AI agent.

FIG. 14A is an example user-interface screen showing an incoming call from an AI agent with AI-behavior monitoring active.

FIG. 14B is an example user-interface screen showing interaction details for an AI-agent call, including permitted delegated tasks.

FIG. 15A is an example user-interface screen showing the handling of text messages requiring identity verification.

FIG. 15B is an example user-interface screen showing the handling of text messages requiring identity verification.

FIG. 16 is an example user-interface screen showing interaction tokens for a text exchange.

FIG. 17 is an example user-interface screen showing a warning when an AI agent behaves outside its permitted boundaries.

FIG. 18 is a diagram showing icons indicating whether a human or AI participant has verified their identity and put it up as collateral.

FIG. 19 is an example settings screen showing options for identity-verification requirements in calls and texts.

FIG. 20 is an example call-history screen showing interaction tokens for prior calls.

FIG. 21 is an example contacts screen allowing a user to designate contacts who must verify their identities.

FIG. 22 is an example interaction-history screen listing interaction tokens and

timestamps for a particular contact.

FIG. 23 is an example settings screen for identity-verification within video-calling applications.

FIG. 24 is an example settings screen for identity-verification in email communications.

FIG. 25 is an example email-inbox screen showing which email senders have verified their identities.

FIG. 26 is an example screen showing remote technical-support interactions in which the support agent verifies their identity.

FIG. 27 is an example screen showing AI-based technical support with AI-behavior monitoring active.

FIG. 28A is an example account-management screen showing verified personal data and system credentials for a human user.

FIG. 28B is an example account-management screen showing AI-agent registration details and delegated tasks.

FIG. 29 is a block diagram showing system components used for AI-behavior analysis.

FIG. 30 is a diagram showing how the system handles calls from individuals who are not system users.

FIG. 31 is a diagram showing how the system handles calls between two system users.

FIG. 32 is a block diagram showing AI-behavior monitoring for AI-initiated calls.

FIG. 33 is a block diagram showing AI-behavior monitoring with an approval loop for AI-initiated calls.

FIG. 34 is a block diagram showing AI-behavior monitoring for text-based interactions.

FIG. 35 is a system-architecture diagram showing identity-verification services, logging, auditing, encryption, and distributed storage.

FIG. 36 is a data-model diagram showing data maintained for human users, companies, AI agents, and interactions.

FIG. 37 is a block diagram of a computer useful in embodiments of the present invention.

### DETAILED DESCRIPTION OF THE INVENTION

In the following detailed description, reference is made to the accompanying drawings that form a part hereof, and in which is shown by way of illustration, specific embodiments in which the invention may be practiced. These embodiments are described in sufficient detail to enable those skilled in the art to practice the invention, and it is to be understood that other embodiments may be utilized. It is also to be understood that structural, procedural and system changes may be made without departing from the spirit and scope of the present invention. In addition, well-known structures, circuits and techniques have not been shown in detail in order not to obscure the understanding of this description. The following detailed description is, therefore, not to be taken in a limiting sense, and the scope of the present invention is defined by the appended claims and their equivalents.

As used in the specification and in the appended claims, the singular forms “a”, “an”, and “the” include plural referents unless the context clearly indicates otherwise. For example, reference to “an analyzer” includes a plurality of such analyzers. In another example, reference to “an analysis” includes a plurality of such analyses.

Where used in this disclosure, the terms “computer” and “end-user device” are meant to encompass a workstation, personal computer, tablet, wireless telephone, or any other suitable computing device including a processor, a computer readable medium upon which computer readable program code (including instructions and/or data) may be disposed, and a user interface. Terms such as “server”, “application”, “engine”, “component”, “module”, “control components/devices”, “messenger component or service,” and the like are intended to refer to a computer-related entity, including hardware or a combination of hardware and, software. For example, an engine may be, but is not limited to being: a process running on a processor; a processor including an object, an executable, a thread of execution, and/or program; and a computer. In another example, a messenger component can be a process executable on a computer or control device to process PLC interactions in accordance with an application that interfaces to a PLC that may alter one or more characteristics of PLC operations. Moreover, the various computer-related entities may be localized on one computer and/or distributed between two or more computers. The terms “real-time” and “on-demand” refer to sensing and responding to external events nearly simultaneously (e.g., within milliseconds or microseconds) with their occurrence, or without intentional delay, given the processing limitations of the system and the time required to accurately respond to the inputs.

Although specific terms are employed herein, they are used in a generic and descriptive sense only and not for purposes of limitation. All terms, including technical and scientific terms, as used herein, have the same meaning as commonly understood by one of ordinary skill in the art to which this invention belongs unless a term has been otherwise defined. It will be further understood that terms, such as those defined in commonly used dictionaries, should be interpreted as having a meaning as commonly understood by a person having ordinary skill in the art to which this invention belongs. It will be further understood that terms, such as those defined in commonly used dictionaries, should be interpreted as having a meaning that is consistent with their meaning in the context of the relevant art and the present disclosure. Such commonly used terms will not be interpreted in an idealized or overly formal sense unless the disclosure herein expressly so defines otherwise.

### General Overview

An aspect of the invention was the recognition by the instant inventors that conventional perimeter-based solutions provide insufficient protection against the growing threat of cyber-fraud. While governments and corporations are attempting to address this threat, they are doing so by establishing perimeters by use of authentication requirements to prevent unauthorized access to their jurisdictions or proprietary commercial platforms. These approaches rely on contracts, background checks, check points, passwords, surveillance software, 2FA, etc.

Moreover, the instant inventors recognized that the security goals of governments and corporations tend to only partially align with those of the consumer or small businesses—often only as far as it impacts their bottom line. It is therefore desirable to empower consumers to own their identity and control who has access to their personal information. Consumers need their own perimeter and a way to hold businesses, individuals, and the owners of AIs who breach their trust, accountable for their actions.

It has also been recognized that anonymity is one of the biggest drivers of cyber-crime. One of the most significant features of the Web has been user anonymity, in which despite some controls, anyone can pose as anyone. This threat is exacerbated by the Web's ability to give individuals geographic reach around the globe. This reach has been credited with unleashing significant advances in human innovation and reshaping the ways in which ideas are shared and consumed. However, this combination of anonymity and reach has also enabled fraud, hate speech, and abuse to be committed with impunity. Where shame and the risk of being caught provide guardrails in the physical world, it can easily be bypassed online. Online crime is a low-risk high-reward proposition due to anonymity.

There is no shame and little risk of being caught. Pre internet, when life was much more localized, people in the same town or region tended to know one another, and one's criminal or anti-social behavior could be exposed and effectively punished in the town square. The fear and shame of bringing disrepute to oneself and to one's family has been a core deterrent to criminal activity, including fraud, over the centuries. Today, the complexity of chasing anonymous cyber criminals across disconnected payments, e-commerce, and social media platforms in multiple jurisdictions, effectively eliminates the aforementioned deterrent and places an enormous burden on law enforcement.

Complexity is a deterrent to reporting and prosecuting fraud. Puzzling interconnectivity preserves anonymity. And it is an incentive to those who would commit fraud. AI agents will only make this worse.

Embodiments of the present invention address the various issues discussed above with a system and method that uses digital identity as collateral to deter fraud in human, business, and AI interactions.

These embodiments provide tools to support personal security, help prevent fraud, and enable prosecution when fraud occurs in a wide range of online transactions and interactions by providing decentralized digital identity with verifiable credentials to create a personal perimeter. Particular embodiments leverage Web3 technology, smart contracts and distributed ledgers to preserve the best of web anonymity for those who are following the rules.

These embodiments effectively require a user to place their identity at stake (without necessarily revealing it to counter parties) with each personal or commercial interaction they or their registered AIs engage in online. An individual's identity becomes collateral in a world built on cyber-based social contracts.

This approach strongly encourages appropriate behavior by adding the risk of being found out, pursued, and punished back into any interaction-regardless of the interaction channel, geography, or parties to the interaction. This includes interactions with businesses and their registered AIs.

An ecosystem to enable identity to be used as collateral.

These embodiments are built on the foundation of digital identity as the KYC (Know your Customer) mechanism for verification, as the source for identity credentials, and for the verified personal data to be used as collateral for interactions.

Conventional digital identity providers and standards groups are focused on authentication (similar to the perimeter-based approach mentioned previously) across a set of data points (ID, eligibility, age, etc.), not on specifically reducing the fraud-risk of an interaction by securely storing the identities and verified residential addresses of interacting parties as collateral against possible future prosecution.

These embodiments address this through a complementary ecosystem, with the use of identity-as-collateral at its core.

Embodiments of the present invention thus provide for:
a. initial verification of each user's identity and collection of verified personal data to use as collateral (also referred to herein as identity staking);
b. Identity verification between interacting parties;
c. Risk assessment, underwriting-allowing insurers to cover certain people, businesses, and machines (AI) and their interactions, thus providing peace of mind to users;
d. Interaction logging amongst the parties to the interaction and secure, encrypted storage of the personal identity information as collateral while preserving anonymity;
e. Tracking of interaction outcomes; and optionally
f. Pursuit of potential consequences for any human-to-human, human-to-machine (AI), human-to-business, and even machine-to machine (AI to AI) interactions that have resulted in provable fraud.

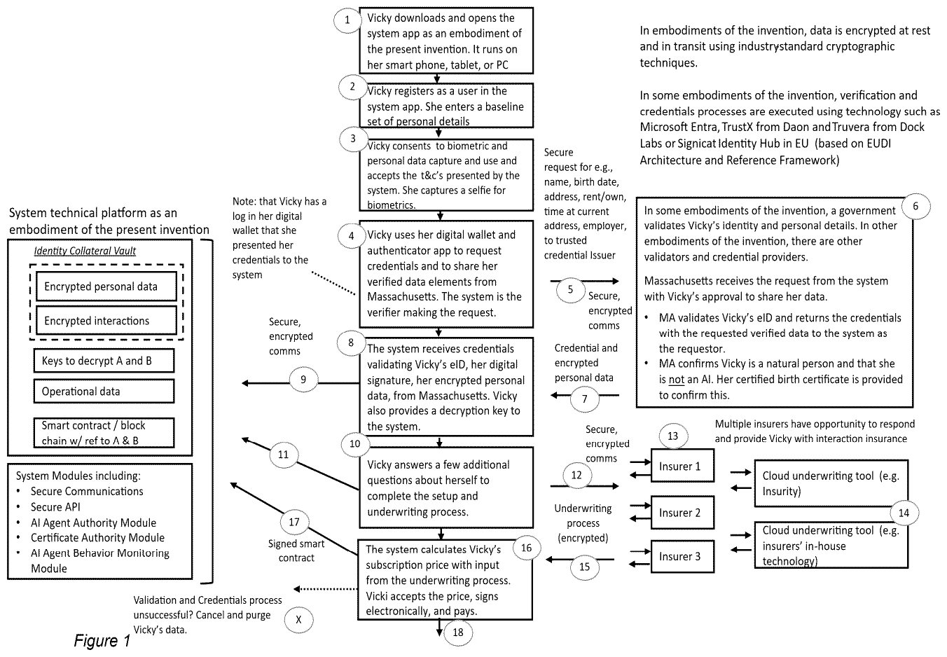

Referring now to the accompanying Figures, embodiments of the present invention will be more thoroughly described. Turning to FIGS. 1-14, various hypothetical use cases of the embodiments hereof will be shown and described. For ease of explication, the embodiments are collectively referred to as the ‘system’.

Referring to FIG. 1, Use Case 1: User On-Boarding-Vicky has friends who have been victims of online fraud. She wishes to become a new user of the system in order to prevent this happening to her. She lives in Massachusetts. The Commonwealth of Massachusetts is recognized by the system as an approved provider (e.g., issuing authority) of verified digital credentials and personal data as inputs to the system. There are additional private identity verification providers servicing the region who can augment the inputs provided by Massachusetts. As shown at 1, Vicky downloads an embodiment of the invention or system in the form of an app from the app store to her smart phone, her PC or other device. (The more devices Vicky has with an embodiment of the invention, the more of Vicky's interactions can be protected by using identity-as-collateral.) At 2, Vicky registers as a user with the system. At 3, she consents to the capture and storage of her biometric data, her personal data, accepts the terms and conditions of the system, and captures a selfie to provide biometrics to the system to confirm that she is a live person. At 4, she passes her eID credentials from her digital wallet to the system. At 5, Vicky's personal data is shared securely with the issuing authority (Commonwealth of Massachusetts in this example) acting as an Identity Validation Provider, who confirms that the personal data is current and in good standing, e.g., confirming a verified residential address, time at the address, employer, and other contact details. In some embodiments of the invention, the system may also verify Vicky's details with private Identity Validation Providers. As shown at 6, the verification process includes Vicky's birth certificate to confirm that Vicky is human. These confirmations are returned to the system at 7, which receives and verifies that it is Vicky who is presenting these credentials and signing up to use the system at 8. The system may then encrypt and securely store Vicky's personal data and interactions within the system at 9. Vicky may then answer any additional questions to complete the setup process at 10, which are then securely stored along with the other parameters of Vicky's user account in the system at 11.

Optionally, at 12, a subset of Vicky's data is passed, in some embodiments through a secure API, to an insurance underwriting process in which various insurers 13 have an opportunity to evaluate Vicky's shared information for the purpose of generating a risk profile and a cost for providing insurance against losses from various types of fraudulent online behavior, at 14. The underwriting process returns inputs at 15, to enable the system to generate a customized subscription price which is presented to Vicky at 16. Vicky may then accept and sign a smart contract which is deployed, in some embodiments of the invention, onto a block chain at 17, and paid for at 18. A set of personal data from Vicky's credentials is encrypted and stored by the system as one of the numerous parameters to her smart contract. Vicky is now an approved user of the system.

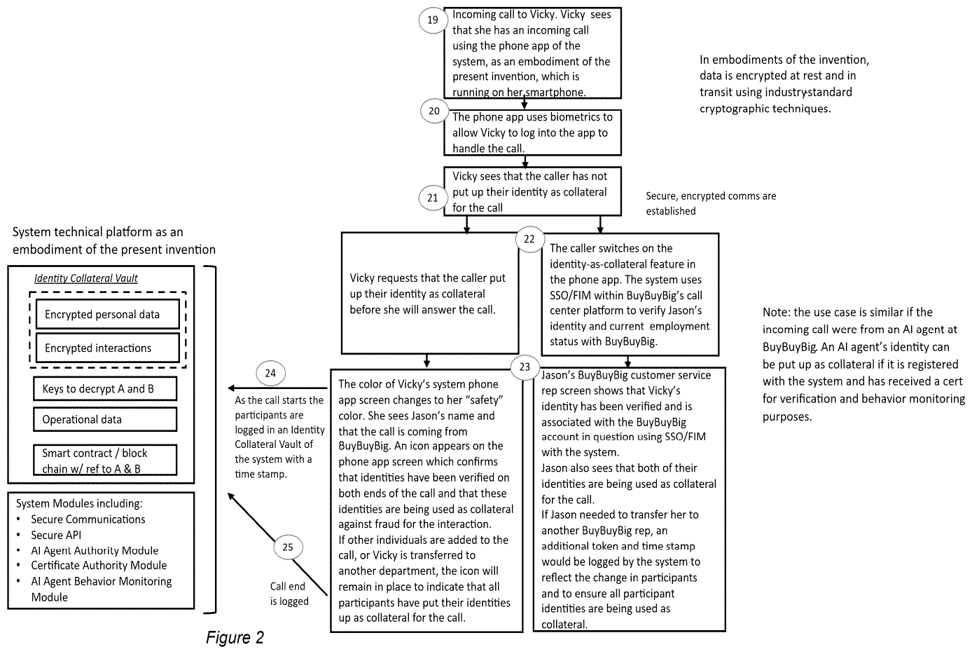

Turning now to FIG. 2, Use Case 2: Call from online retailer BuyBuyBig-Vicky receives a phone call from someone she doesn't recognize at 19. She uses biometrics to log into her phone to handle the call at 20. A system icon/badge, also known as an identity-as-collateral icon/badge, on her phone screen shows that the caller is not using their identity as collateral at 21. Vicky requests at 22, e.g., by tapping on the identity-as-collateral request icon of the system, that the caller put up their identity as collateral before she will accept the call. In response, the caller switches on the identity-as-collateral feature, e.g., by tapping on the icon on the caller's system to put their identity up as collateral, in response to Vicky's request. The system then registers that the system credential from Jason, the caller, is confirmed and that he is a verified BuyBuyBig employee, and that Jason is a human and not an AI agent. At 23, Vicky sees the system identity-as-collateral icon on her phone screen which indicates that the caller has now put up their identity as collateral, and sees, for example, that the caller is Jason from BuyBuyBig. The call is logged by the system against the smart contracts that the system has with Vicky, with Jason the BuyBuyBig customer service rep, and with BuyBuyBig, Jason's employer.

As the call begins, a unique key (Interaction Token) is built for this interaction by the system and logged by the system as shown at 24.

Vicky can trust the caller and his employer (BuyBuyBig) because they have put up their identities as collateral for this call. She sees that the color of the screen on her phone has changed to a color she selected when setting up the parameters of the system embodied, in this case, as an app on her phone device. This screen color provides additional reassurance that the system is working properly. Vicky proceeds with the call.

The BuyBuyBig rep sees Vicky's verified credentials as provided by the system, and relies on this for customer authentication. He records the system interaction token id for the interaction in BuyBuyBig's call center app in line with BuyBuyBig's protocols, confirming that Jason has interacted with Vicky, the verified account holder. It is noted that this process happens in real-time, e.g., at sub-second response times, and that it is second nature to Vicky and the BuyBuyBig customer service rep to invoke it as part of their call. The end of the call is logged at 25. Vicky can tap the icon on her system screen to see this unique token ID that was generated and use that as a reference code should she need to contact the provider of the system, in this embodiment, about the particular interaction she had with Jason from BuyBuyBig, in the future.

In particular embodiments, the interaction remains in Vicky's and BuyBuyBig's interaction log in an Identity Collateral Vault of the system for a predetermined period of time, e.g., 18 months. If Vicky discovers fraud that resulted from that interaction, she can, in conjunction with, e.g., a warrant from local law enforcement, request that the system provider enable the release of the specific identity of the person she spoke with on the call to support a fraud investigation and potential prosecution. The system then decrypts the personally identifiable data using the keys provided by Vicky and BuyBuyBig when they first were setup as users in the system. The results of that investigation are recorded and may be included in data provided by the system to insurers for future underwriting decisions.

It should be noted that benefits provided by these embodiments include Vicky's expectation that using the system deters criminals from attempting to contact her about her BuyBuyBig (or any other) account in a potential account takeover scheme, etc., given the requirement for putting up one's identity as collateral for the interaction and potential prosecution if fraud is discovered. It should also be noted that callers would have the option to put up their identities as collateral automatically for every call they make, thus bypassing the need for the call recipient to request that their identity be used as collateral as part of answering each call. Moreover, the aforementioned use case would be similar if the call were made by an AI agent from BuyBuyBug, rather than from a human representative. A difference would be that each AI agent would need to be registered on the system along with a Responsible Human and a Responsible Organization, e.g., BuyBuyBig, and a human employee at BuyBuyBig would be held responsible for the AI agent's behavior.

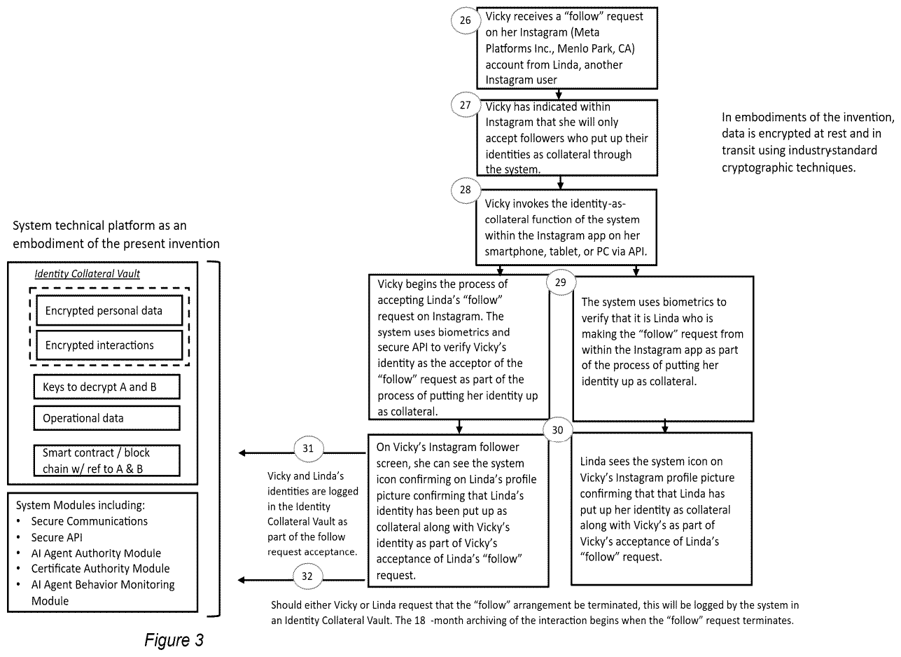

Turning now to FIG. 3, Use Case 3: Being Followed on Social Media-Vicky is approached, at 26, by another user on a social media platform who wants to follow her posts. She has indicated on her social media platform, at 27, that she will only accept followers who are authenticated via the system and are willing to use their identities as collateral. This user and Vicky exchange system credentials, e.g., by tapping an icon generated by the system on the social media app, in some embodiments via secure API, with the system verifying each party at 29.

Both parties see, at 30, the system identity-as-collateral icon in the corner of the social media app screen validating that each has now put up their identities as collateral. Each of them can click on the icon to see the unique interaction token generated by the system for the connection/interaction.

Should either of their credentials be revoked by the system, e.g., because either of them failed to renew their credential verifications as required periodically by the system, the request would be logged by the system at 32 and they would lose the social media connection and would need to re-connect once the credentials for both parties are verified again by the system. The fact that they had a social media connection would be logged at 31 for both parties by the system against their credentials and smart contract for the duration of the social media relationship, and for a predetermined period, e.g., 18 months, thereafter. Note that either party may unilaterally terminate the social media connection in the system at any time.

Note that neither party knows more about the other person than what they are sharing through their usernames and posts on social media. However, the fact that each of them has put up their identities as collateral through the system provides peace of mind to the posts and responses. Posts are logged by the social media platform as usual. The link between the two users is logged within the system. And since identities are used as collateral, the risk of being caught and prosecuted should deter abusive behavior, catfishing, and fraud.

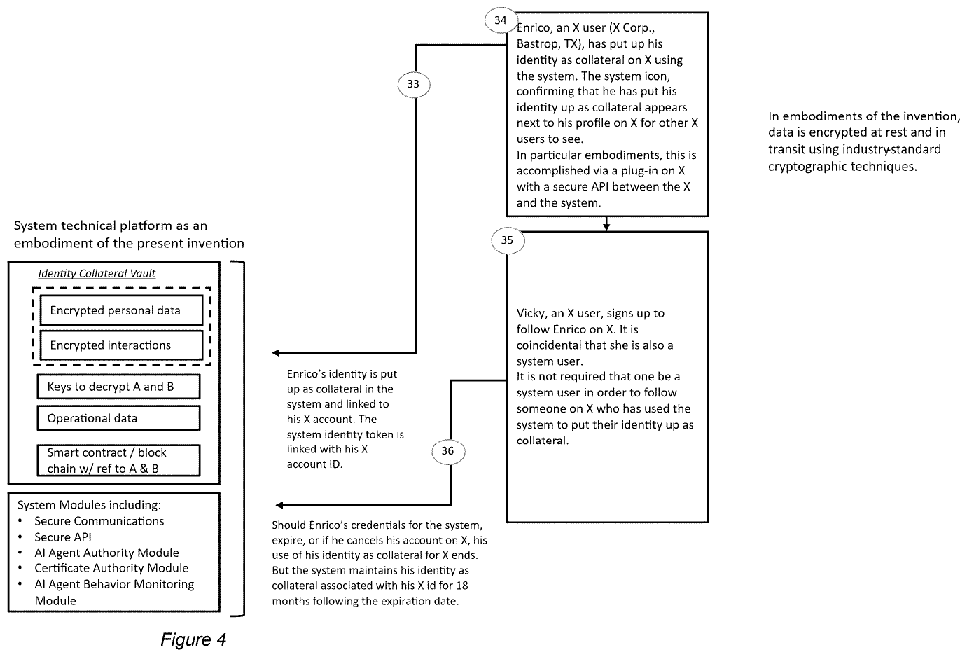

Turning now to FIG. 4, Use Case 4: Following an X Account-Vicky would like to follow a user who posts on X (X Corp., Bastrop, TX). The user, Enrico, has put up his identity as collateral using the system, as shown at 33. Vicky sees an indication of this on the X interface at 34. This gives Vicky, and the thousands of other followers of this X account, shown at 35, the confidence that the user's true identity and location is being used as collateral against their posts on X. While the poster remains anonymous on X, the fact that their identity could be uncovered through legal proceedings should shape their choice of posts and language. In the event Enrico's credentials expire or he cancels his account on X, the system will be notified at 36, prompting the system to terminate use of the identity token of the system on the user's X account. The communication between the system and the social media platform, in this embodiment of the invention, is via a secure API.

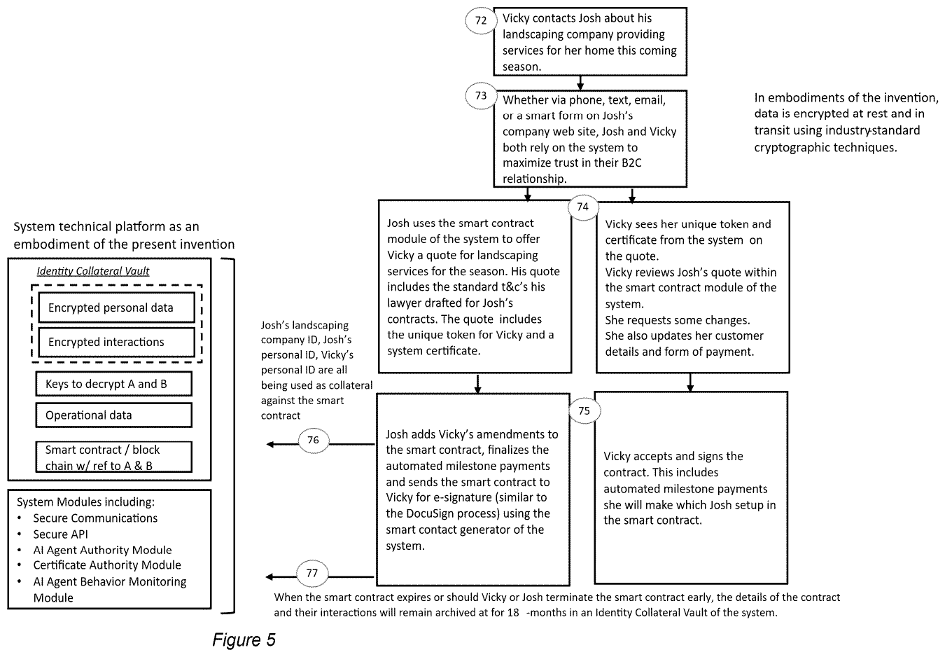

Turning now to FIG. 5, Use Case 5: Human-to-Human Business Interactions-use of the inventive system to facilitate day-to-day commerce and deter fraud. Vicky needs to arrange for a landscaping service for her home. She contacts Josh, at 73, who owns a local landscaping company based just over the border from Massachusetts, in New Hampshire. Josh has a digital ID issued by the State of New Hampshire. He is registered and authenticated as a user of the system as shown and described hereinabove with respect to FIG. 1. His landscaping service is a small business and is also registered with the system and has confirmed that the company sponsors Josh as one of its employees, also as shown and described hereinabove. The business's credentials, in good standing, are supplied to the system via the Secretary of State of New Hampshire.

Vicky and Josh use the system at 73 to communicate as described hereinabove, to provide a cost estimate at 74, and to finalize a smart contract for the summer landscaping season with parameters for the work to be provided and the terms of payment. They each put up their identities as collateral using the system as part of signing the contract at 75. Both parties have increased peace of mind that each party is likely to honor the terms of the agreement.

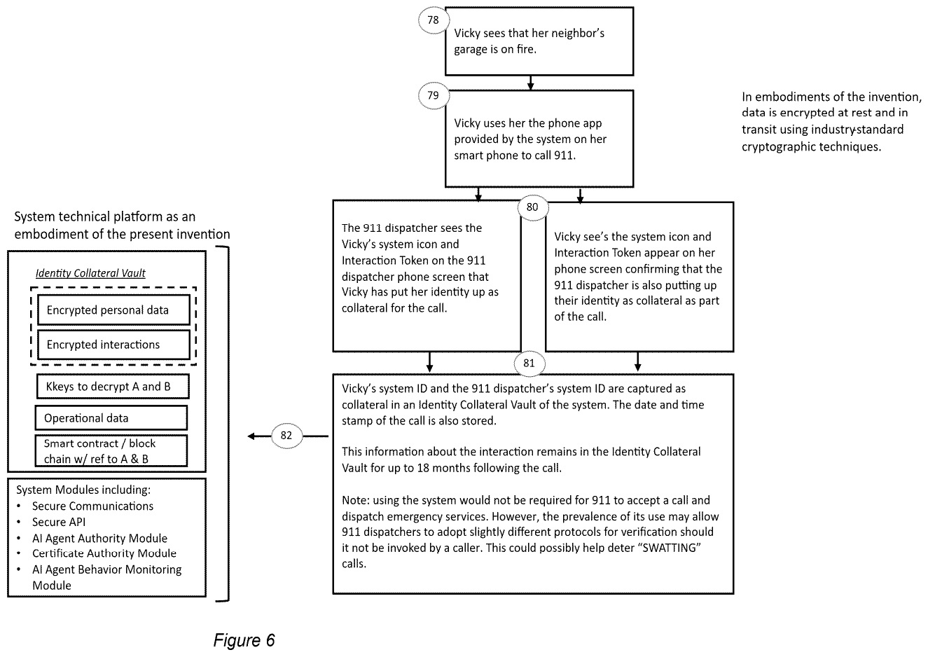

Turning now to FIG. 6, Use Case 6:911 Call-Vicky sees that her neighbor's garage has caught fire at 78. She calls 911 at 79 on their behalf to get a fire crew dispatched to put it out. Vicky has configured her system to automatically put up her identity as collateral for all 911 calls. Both Vicky and the 911 operator see each other's token IDs on their screens at 80, to confirm that their identities have been put up as collateral. Both party's IDs are captured by the system as collateral at 82, as having participated in the 911 call, and are stored, e.g., for up to 18 months following the call.

Vicky has now effectively put up her identity as collateral against that 911 call. If there is an investigation of the call, 911 can work with law enforcement and the provider of the system to access Vicky's identity and residential address with a subpoena. This can prevent prank calls to 911 or the practice of Swatting. Note that the 911 service would accept any call with or without identities being put up as collateral in the system, but the growing adoption and automatic nature of using identities as collateral by users of the system should reduce the risk of Swatting, over time.

Use Case 7: Business Fraud-Fred is the CEO for a company that designs and manufactures complex measurement instruments for the steel industry. His company is approached by someone overseas who wants to buy the product, which typically costs $30,000. The buyer sends a check for $120,000. In the communications that ensue, the instrument company offers to cash the check and wire the overpayment back to the buyer. It turns out the check was bogus, and the buyer is hoping the cash refund will move more quickly than the discovery of the bogus check.

In particular embodiments, Fred's sales team could have required that the buyer put up their identity as collateral for the transaction, such as shown and described hereinabove with respect to FIG. 5. This may have been a deterrent to the attempted fraud. In the least it would have presented a clearer path to prosecution had the fraud scheme succeeded.

Use Case 8: Application Administration as an embodiment of the invention-Vicky can log into the administrative tools of her system account to do the following:
Update her subscription payment information for the system;
Review her interaction insurance policy/coverages and periodically request a new quote;
Review the list of her interactions that are currently active/on-going or within the 18-month Identity Collateral Period;
See which archived interactions are set to be purged because the 18-month Identity Collateral Period time limit is approaching;
Update her credentials and additional personal details.

Note that any change to a key element of her identity, such as name, phone number, residential address or the expiration of her eID credentials require her to go through the certification and underwriting process within the system. As long as Vicky's credentials and data are updated without a lapse, the system can maintain continuity between old and newly updated credentials across interactions where she has used her identity as collateral. Should Vicky's credentials lapse, tokens and certificates are no longer displayed on the system app screens and system users will need to renew their identities as collateral with other system users.

Use Case 9a: Call from an AI agent refusing to put its identity up as collateral. Vicky receives a phone call which shows the call is coming from a company called MemeWallet. Vicky has a MemeWallet account so she is inclined to accept the call. Vicky looks for the familiar token and system identity-as-collateral icon that appear on her system phone app to be certain that this AI agent caller is registered with the system and that its specific identity and its owner's (Responsible Human and Responsible Organization) identities are available as collateral in conjunction with this call. She sees that the caller has not put up their identity as collateral for the call.

Before accepting the call Vicky requests that the caller put up their identity as collateral. Even when requested, the caller refuses to put up their identity as collateral. Vicky hangs up and reports the call as SPAM to her phone service provider.

Had the AI been able to present system credentials as collateral, Vicky would have likely engaged with the AI. She and the AI would have put up their identities as collateral in the system. The interaction would have then been similar to Use Case #2 as shown and described hereinabove with respect to FIG. 2, but with an AI agent putting up its identity as collateral in conjunction with the identity of the business owner/provider of the AI agent.

Use Case 9b: Call from an AI Agent using its identity as collateral. Vicky receives a phone call which shows the call is coming from MemeWallet. Vicky has a MemeWallet account, so she is inclined to accept the call. She sees the system icon that indicates that the caller has not put up their identity as collateral for the call. Before accepting the call, Vicky requests that the caller put up their identity as collateral. The caller accepts Vicky's request and puts up their identity as collateral on the system.

Vicky thus sees from the new identity-as-collateral icon that appears on the screen of her system phone app that the caller is an AI agent, that its owner (MemeWallet) has registered it with the system, and that the AI agent has put up its identity as collateral for the call. The AI agent uses Vicky's identity she has put up as collateral for the call and her credentials to validate that she is the account holder and records the interaction token generated by the system in the MemeWallet customer service log at MemeWallet. Vicky accepts the call and engages with the AI agent about an issue with someone making multiple unsuccessful attempts to log into her MemeWallet account. She clarifies that she was the one making those attempts. The issue was that her authenticator app was out of synch. The AI agent helps her fix the issue.

Note that the interaction is similar to Use Case #2 as shown and described hereinabove with respect to FIG. 2, but with an AI agent. Since she is interacting with an AI agent, in this embodiment of the invention, Vicky may optionally invoke an AI Agent Behavior Monitoring Module of the system. This module evaluates the AI agent's behavior along multiple dimensions in real-time. If the AI agent is overstepping its authority or misbehaving outside social norms, the system will warn Vicky and give her the option to terminate the interaction. The AI Agent Behavior Monitoring Module will be described in greater detail hereinbelow.

Use Case 9c: Identity as collateral in human-to-machine (AI agent) and machine-to-machine (AI agent to AI agent) interactions. The aforementioned aspects of the inventive approach that allow users to put up their identity as collateral verify that the individuals on either side of an interaction or transaction are human, based on the KYC process of digital IDs being issued. Inputs to ensure these are humans may include certified birth certificates provided during the onboarding process as each becomes a verified user of the system. Additionally, biometrics and liveness tests are used to distinguish humans from machines/AI agents in each interaction.

The aforementioned insurance underwriting process distinguishes between humans and AI agents when insuring contracts and interactions. In some embodiments, the system provides a separate certification/credentialling process and an AI identity collateral solution to cover human-to-machine and machine-to-machine interactions.

In particular embodiments, the system may require the AI agent (whether a high risk or non-high-risk AI) to be registered by its provider with a government-managed AI registry-similar to the one proposed in EU Article 71 of the EU AI Act. The system then builds its identity-as-collateral certificates (certs) for the AI agent based on verification and certification from sources such as this one. In other embodiments, the system may provide its own AI agent registration function as a stand-in when government or industry solutions for registering AI agents are inadequate or non-existent.

Various embodiments may also, or alternatively, require the AI to be registered by a Responsible Human with system credentials. The Responsible Human may also be a verified employee of an organization (legal person) with their own system credentials. The AI agent's credentials, along with the Responsible Human and the Responsible Organization credentials are used as collateral together as part of each machine-to-human or machine-to-machine interaction or transaction in which the AI agent engages.

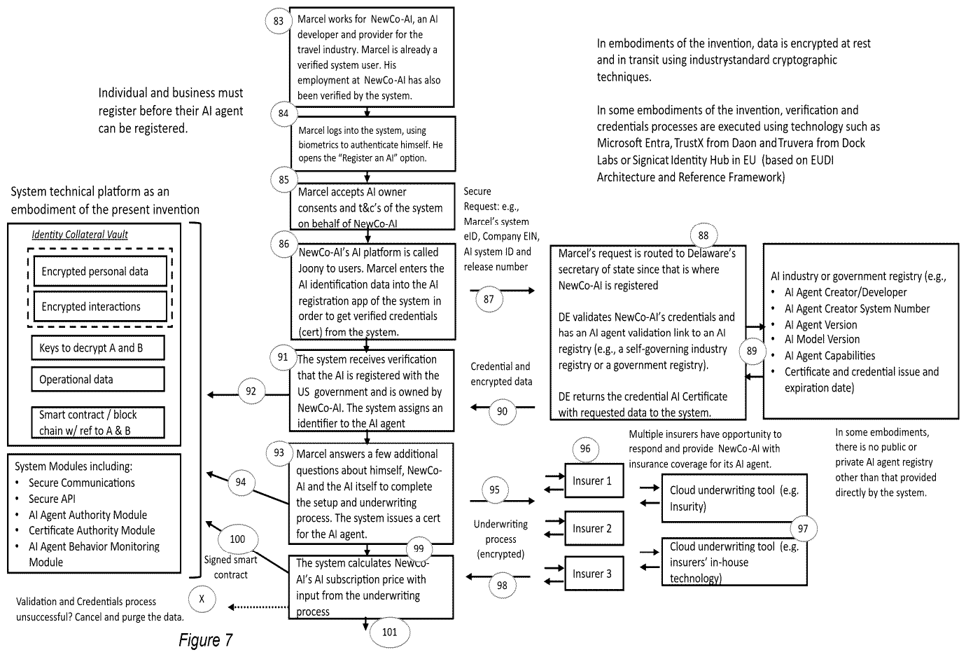

Referring to FIG. 7, an example of an AI registration process in accordance with embodiments of the present invention is described. As shown at 83, Marcel works for NewCo-AI, an AI developer and provider for the travel industry. Marcel and his company have already been verified by the system. At 84, Marcel logs into the system and opts to ‘Register an AI Agent’. Marcel accepts the terms and conditions of the system as an AI owner at 85, and enters AI identification data at 86 to register the AI. At 87, Marcels's eID, company data (e.g., EIN), etc., are sent to an approved provider (e.g., issuing authority) of verified digital credentials and personal data, which in this example is Delaware's Secretary of State 88 in cooperation with an industry or government AI registry 89, who returns an AI certificate to the system at 90.

The system receives verification that the AI is registered with a Verifying Authority and is owned by NewCo-AI at 91. The system then assigns an ID and issues a certification to the AI and logs this to the system Identity Collateral Vault at 92. Marcel completes the setup process at 93, optionally completes the insurance underwriting process at 95-98, and the system calculates at 99 and delivers to Marcel a subscription price/contract at 101. Note that in cases where an industry or government AI registry is unavailable, the system itself directly registers the AI agent.

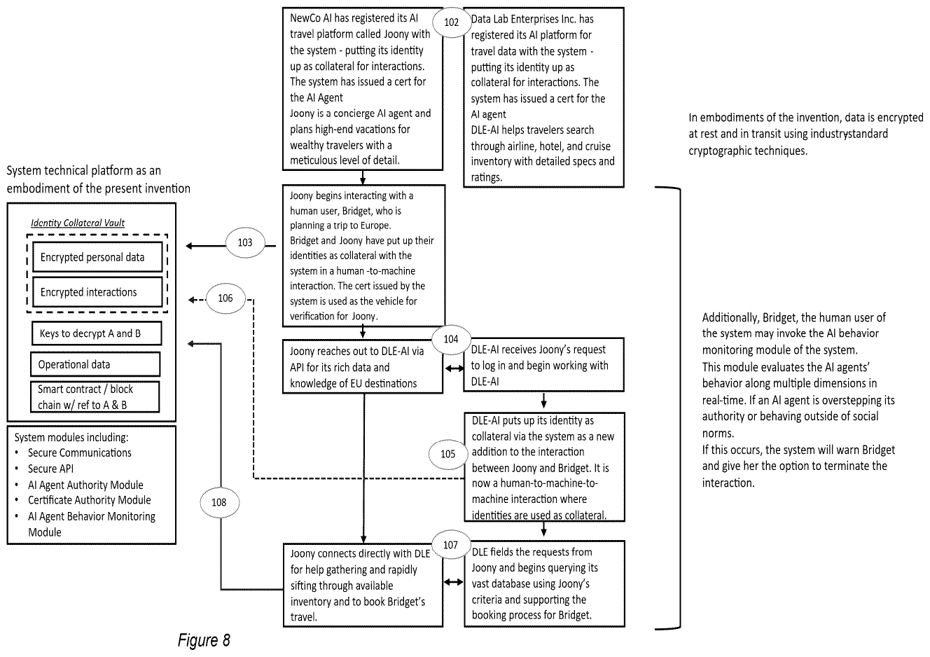

Referring to FIG. 8, an example of a machine-to-machine transaction in accordance with embodiments of the present invention is described. At 102 NewCo-AI has registered its AI travel platform ‘Joony’ with the system, and Data Lab Enterprises has registered its AI platform (‘DLE-AI’) in the system for travel data. At 103, Joony begins interacting with a human user, Bridget, who is planning a trip. Both Joony and Bridget have put up their identities as collateral with the system. At 104, Joony and DLE-AI begin communicating, with DLE-AI putting up its identity as collateral at 105, and completing the booking process for Bridget at 106. The end of the call is logged with the system at 108.

It should be noted that whenever an AI agent is involved in a transaction or interaction, the system may optionally provide the AI Agent Behavior Monitoring Module. In these embodiments, once an AI agent's cert has been verified and the system user can trust that the AI agent and a Responsible Human (and possibly a Responsible Organization) have staked their identities against fraud occurring in the interaction, there is the option for the system user to invoke the AI Agent behavior monitoring Module of the system.

The AI Agent behavioral monitoring Module is available to system users to engage automatically or manually across the touchpoints in which the system operates and when an AI agent is at least one of the parties to an interaction. The AI agent's cert contains information about what the AI agent is capable of. It also includes information about the AI agent's delegated tasks/permissioned behaviors. These data points are used as inputs into the AI Agent Behavior Monitoring Module of the system to create a baseline behavioral boundary and understand the risks of the AI agent overstepping its authority.

These embodiments may monitor voice, voice tone, text, video, graphics, photos for any behavior that is not acceptable social behavior and/or behavior that goes beyond what the AI agent has authority to do. The system AI Agent Behavior Monitoring Module may alert the user that the AI agent has overstepped and give the user the option to terminate the interaction. In particular embodiments, the interaction outcome is logged as input into future risk assessments of that particular AI agent and other AI agents. The outcome is used as input into the insurance underwriting process. A substantially constant handshake throughout the interaction via the system gives the user the security that the interaction is constantly being monitored and that the AI agent has put their identity and that of a Responsible Human and Responsible Organization up as collateral against a fraudulent interaction. In particular embodiments, the AI agent monitoring module records the text, voice, and/or video during the interaction between an AI agent and the human or between AI agents (machine-to-machine). Should the interaction conclude with no AI agent behavior breaching the boundaries of the AI agent's cert, the recorded voice, text, and/or video are deleted by the system.

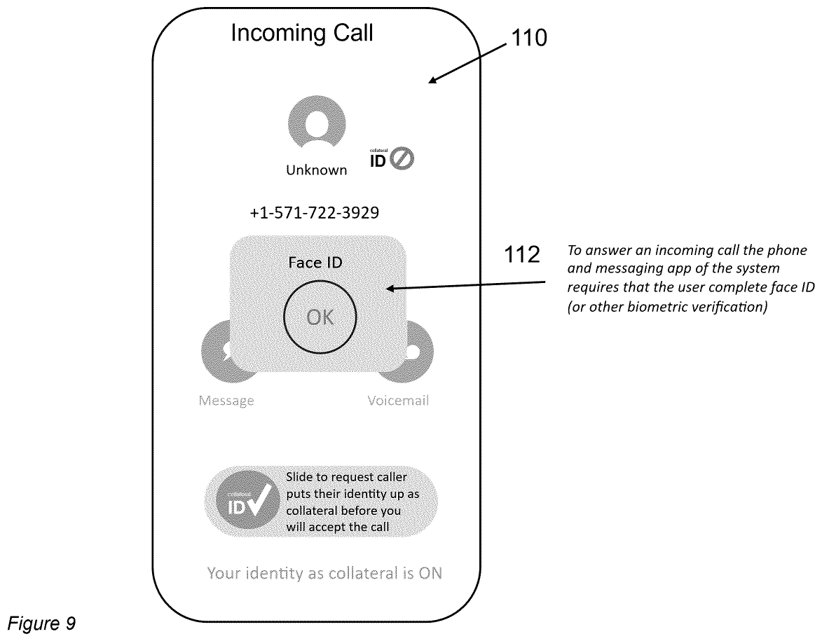

Turning now to FIGS. 9-17, exemplary graphical user interfaces (GUIs) associated with the foregoing Use Cases are shown and described. In FIG. 9, a GUI handling steps 19-21 for an incoming call via a phone and messaging app of the system, displays the incoming caller's phone number along with an identity icon 110 indicating whether the caller's identity has been offered as collateral. The GUI also includes a biometric verification button 112 requiring the user to confirm their identity, e.g., by face ID, before being permitted to answer the incoming call.

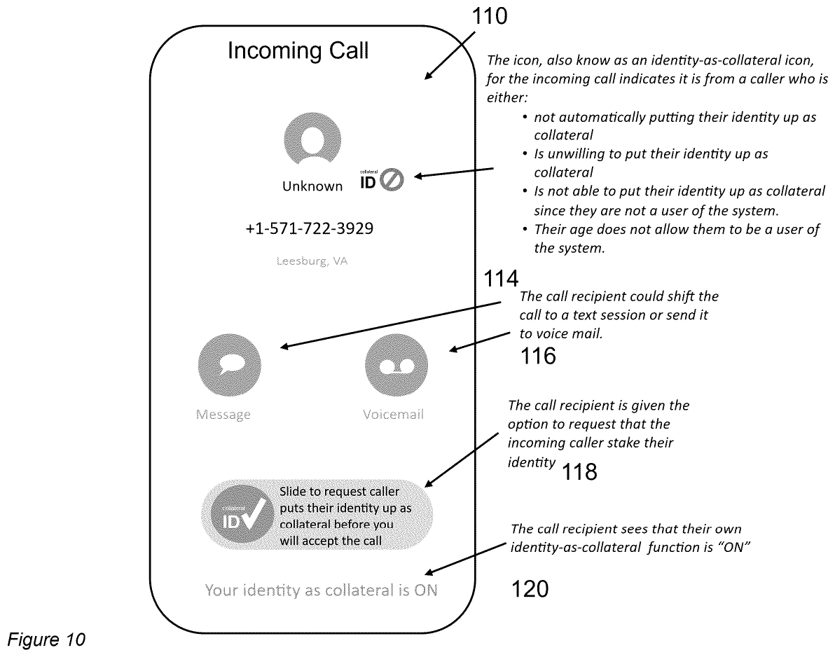

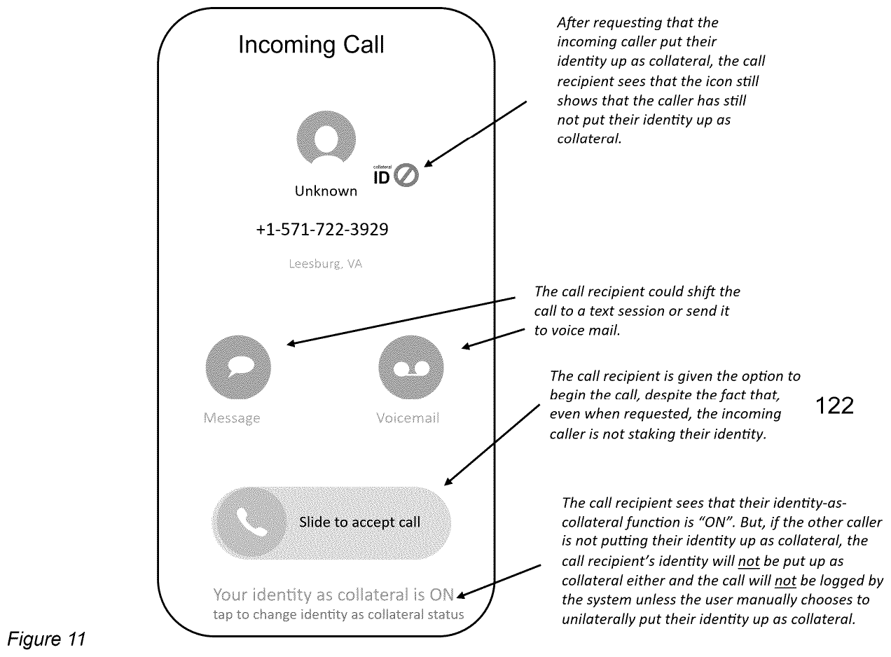

As shown in FIG. 10, the GUI includes text and voicemail buttons to enable the user to shift the call to a text session or voicemail at 114, 116, respectively. An ID request button 118 lets the user request that the incoming caller put up their identity as collateral, and an ID indicator 120 indicates whether the user's own identity has been put up as collateral for the call. As shown in FIG. 11, in particular embodiments, once the ID request button 118 has been actuated, the GUI provides an acceptance button 122 that permits the user to answer the call regardless of whether the caller has put up their identity as collateral.

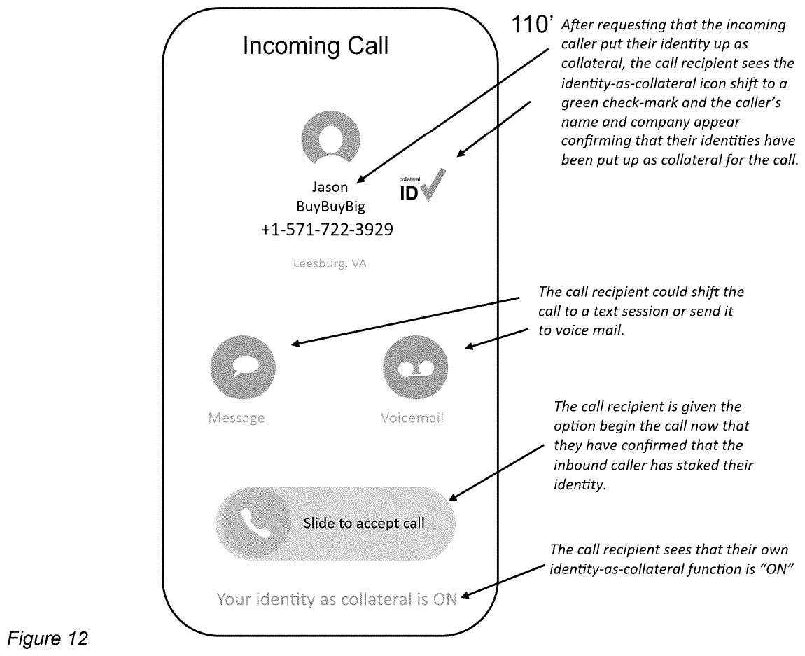

Turning now to FIG. 12, at step 22 (FIG. 2) if the caller puts up their identity as collateral, either before making the call or after a user request via ID request button 118 (FIG. 11), the identity-as-collateral icon toggles to, e.g., include the caller's name and a checkmark or other indicator to confirm that identity has been put up as collateral, as shown at 110′.

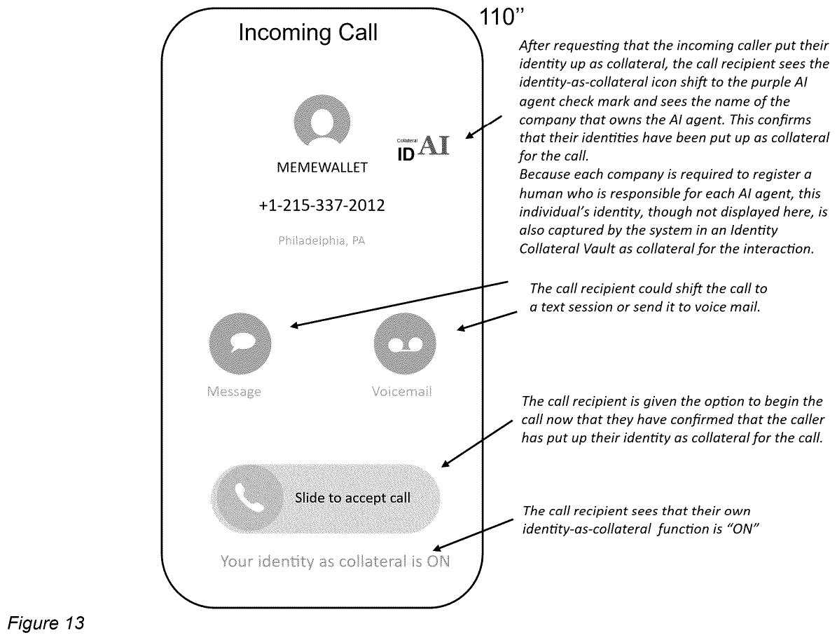

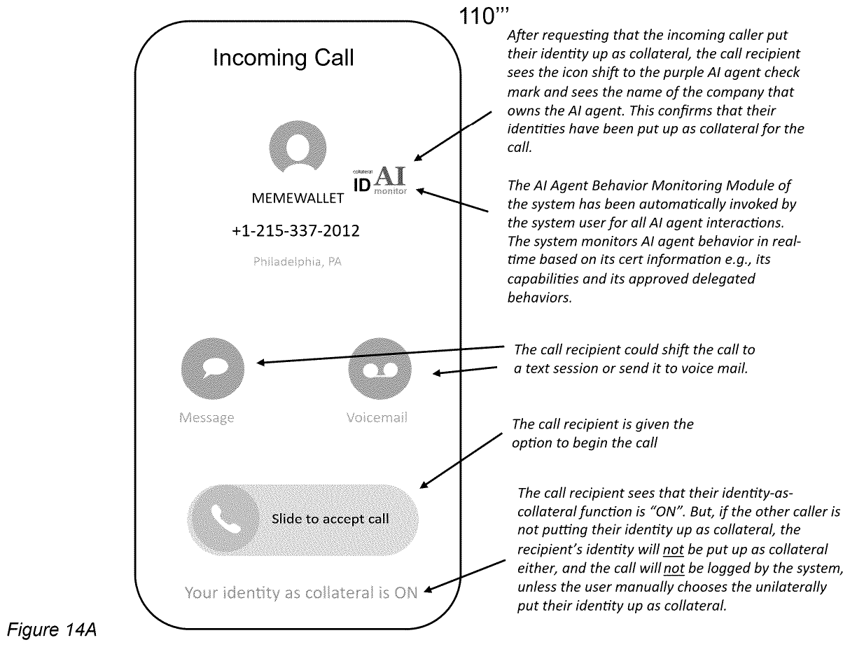

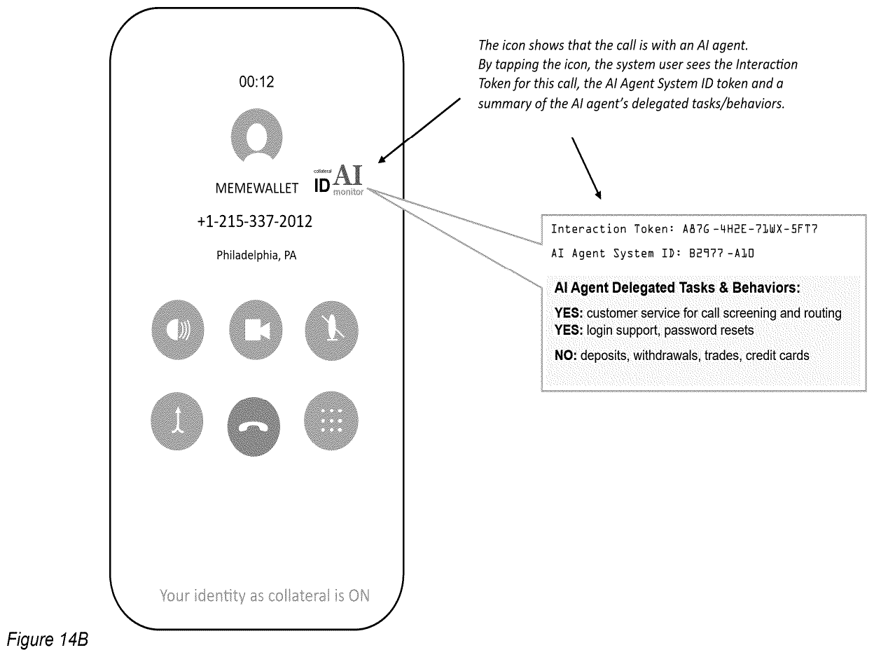

FIGS. 13, 14A and 14B are substantially similar to FIG. 12, except that the identity-as-collateral icon is configured to indicate that the caller is an AI agent, at 110″ in FIG. 13, and indicates that the AI Agent Behavior Monitoring Module has been actuated at 110′″ in FIG. 14A. In FIG. 14B, the system user may tap the identity-as-collateral icon to see the Interaction Token for the call, the AI agent's Identifier assigned by the system, and the AI agent's delegated tasks/behaviors. This helps the system user be aware of the AI agent's behavioral boundaries at any time during or after the interaction.

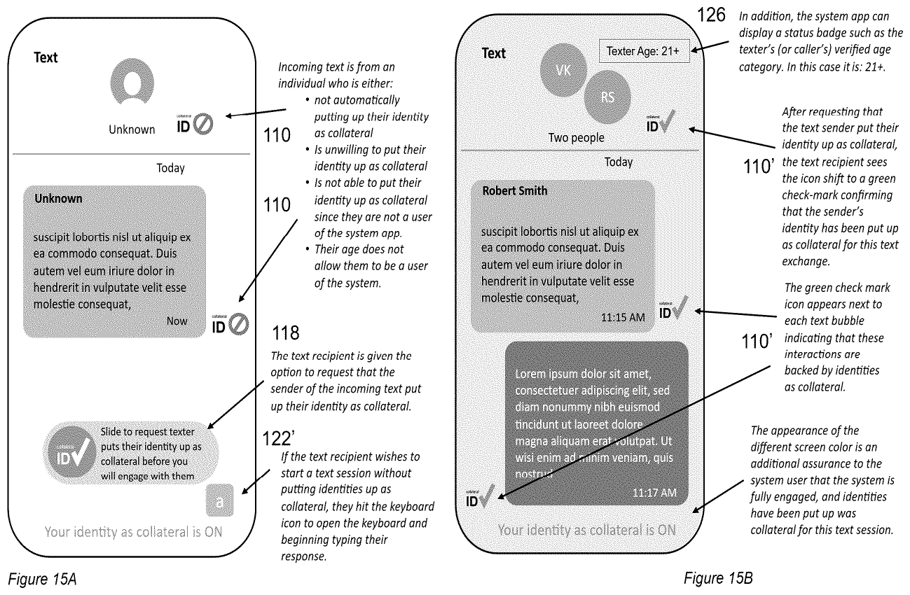

Turning now to FIGS. 15A and 15B, a GUI handling incoming text messages on a phone and messaging app is shown and described. In particular embodiments, identity-as-collateral icon 110 is displayed adjacent both the incoming texter's icon and each text bubble as shown. In addition to ID request button 118, the GUI includes an acceptance button 122′ that permits the user to respond to the text regardless of whether the incoming texter has put up their identity as collateral. As shown in FIG. 15B, the ID request button has shifted to indicia (e.g., a checkmark) at 110′ confirming that the texter has put up their identity as collateral for the text exchange. The GUI may also display a status badge indicating, in this embodiment, the texter's verified age category, as shown at 126. Moreover, the GUI may display an alternate appearance, e.g., screen color, as an additional assurance that the system is fully engaged and that identities are being put up as collateral for this communication (text) session.

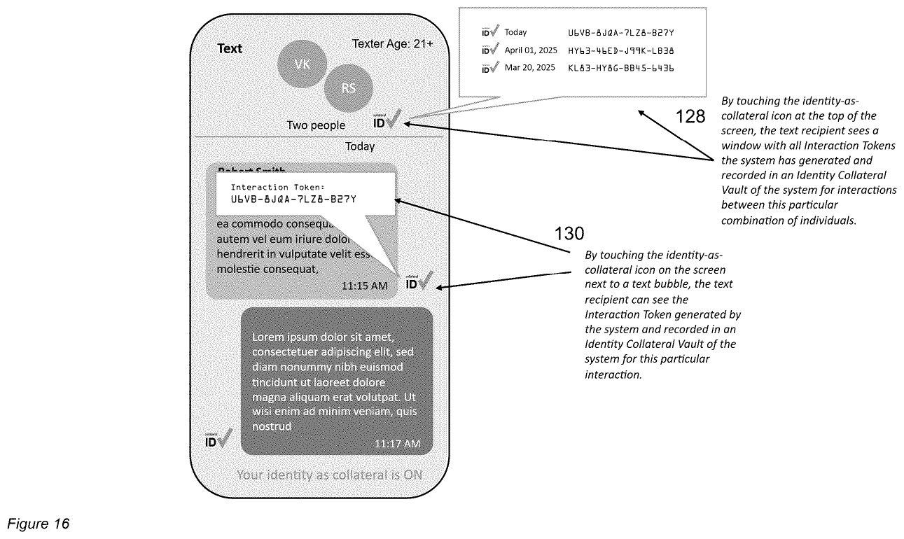

As shown in FIG. 16, in response to selection of the identity icon 110′ for the participants and/or for the individual text bubbles, the GUI displays the interaction token(s) generated and recorded in an Identity Collateral Vault of the system for the particular individuals and interactions, as shown at 128 and 130, respectively. In particular embodiments, it should be noted that for privacy purposes, the interaction token visible to the call recipient is different from the interaction token visible to the caller. This helps ensure that an unauthorized party would not be able to connect the two parties as knowing one another or having interacted with one another. However, these interaction tokens are linked within the system to ensure the appropriate logging of interaction details as part of each party putting up their identity as collateral.

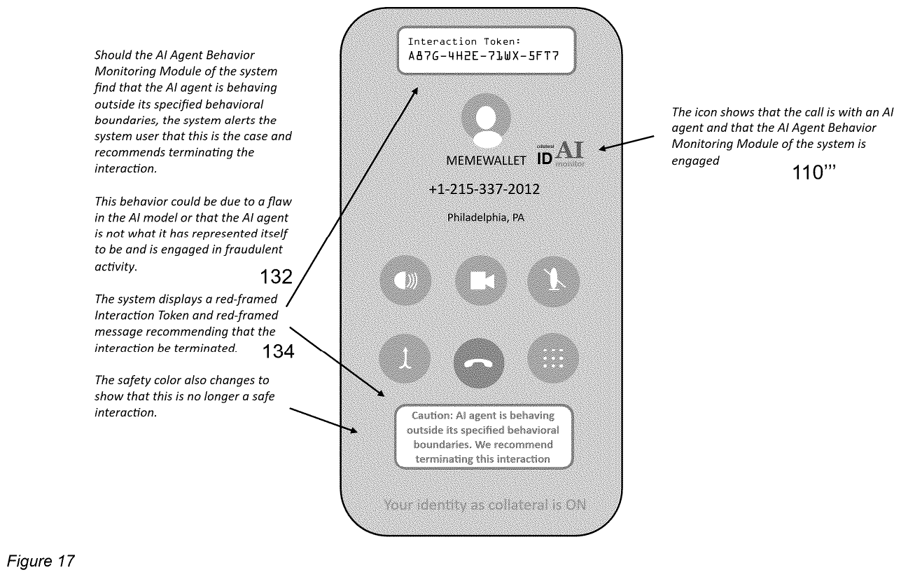

Turning now to FIG. 17, a GUI handling use case steps 23-25 for AI agent behavior monitoring is shown and described. Initially, identity icon 110′″ shows that the call is with an AI agent and that the AI Agent Behavior Monitoring Module of the system is engaged. In particular embodiments, in the event that the system finds that the AI agent is operating outside its specified behavioral boundaries, the system alerts the user that this is the case and recommends terminating the interaction. Such behavior may be due to a flaw in the AI model or possibly that the AI agent is not what it has represented itself to be and is engaged in fraudulent activity. Particular embodiments may alert the user, e.g., by displaying a red-framed interaction token and/or a red-framed notice, a change in screen background color, and haptic alerts recommending termination of the interaction as shown at 132, 134, respectively.

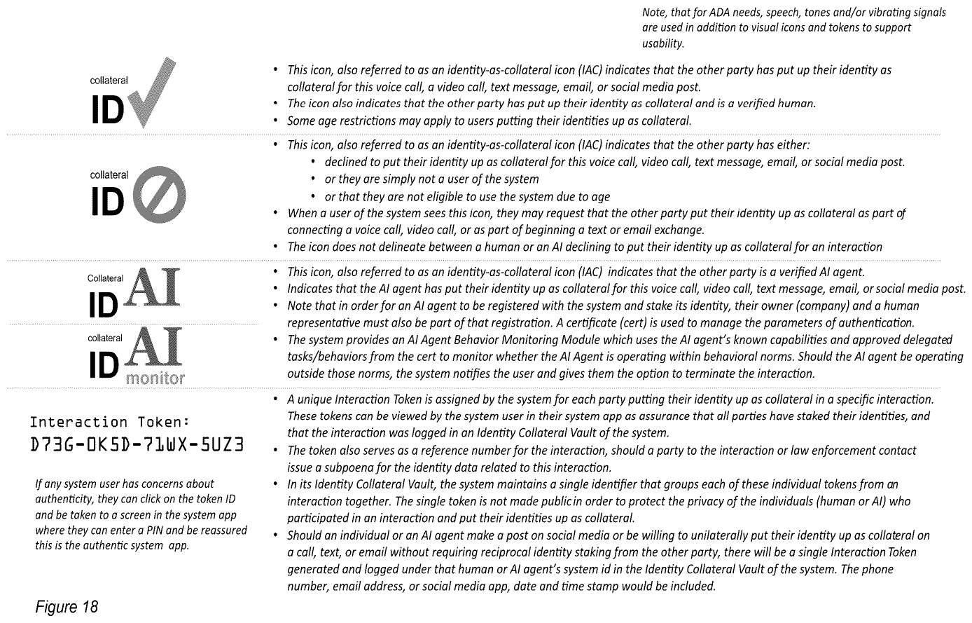

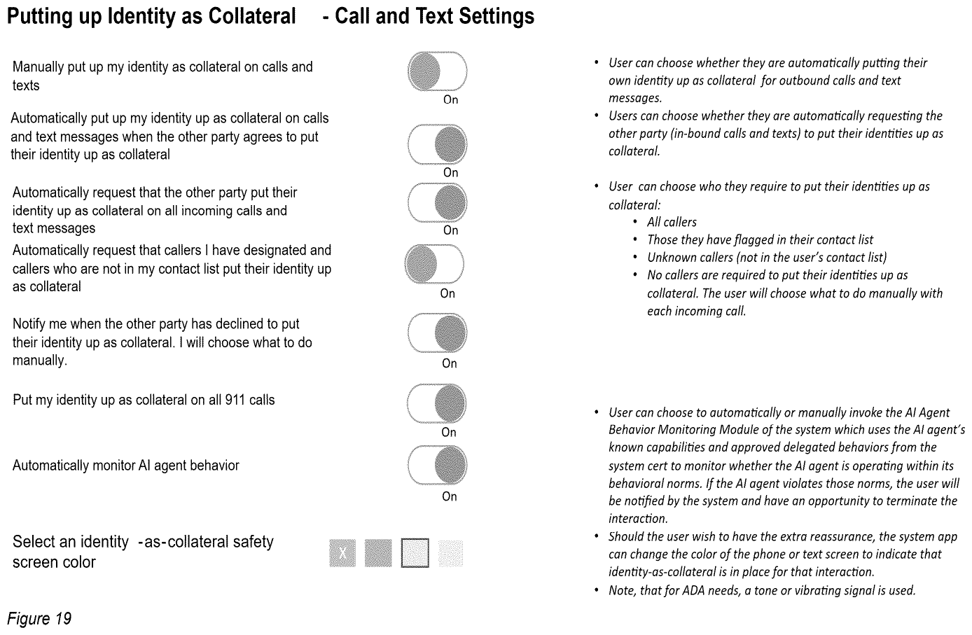

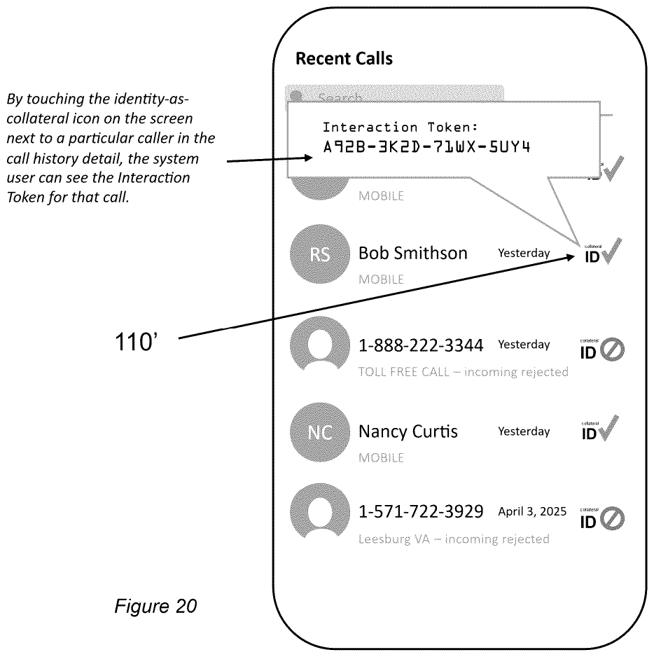

A list of exemplary identity-as-collateral icons, identifiers and definitions are shown in FIG. 18. An exemplary set of call and text settings for the system are shown in FIG. 19. As shown in FIG. 20, the GUI permits a user to select the identity icon 110′ adjacent to a particular caller in the call history screen, to see the interaction token for that call/interaction.

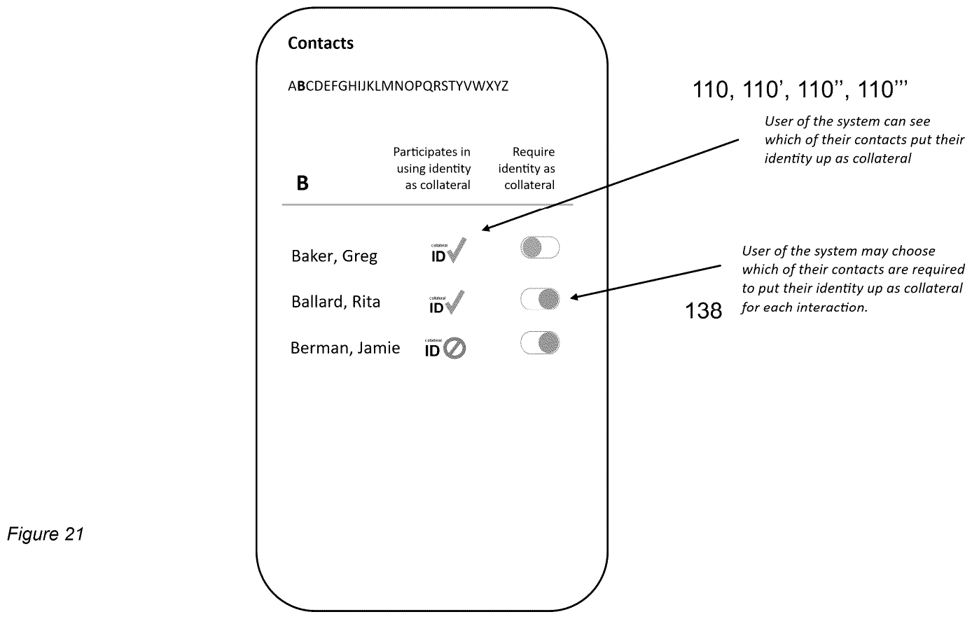

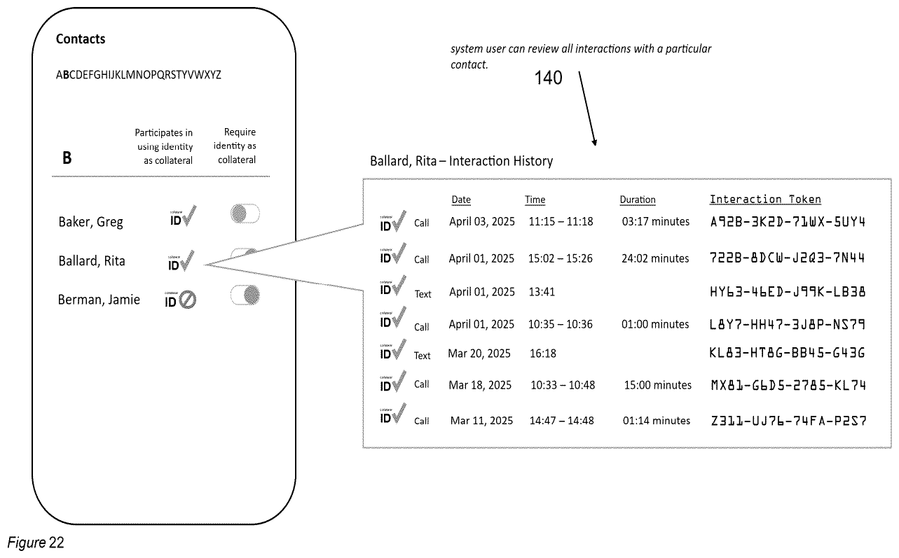

As shown in FIGS. 21 & 22, in particular embodiments, the GUI contacts screen displays the applicable identity-as-collateral icon 110, 110′, 110″, 110′″ adjacent their contact information so the user can see which of the contacts have put up their identities as collateral in accordance with the present invention. Particular embodiments also permit the user to select whether to require identity as collateral for individual contacts, at 138 (FIG. 21). Also in the contacts screen, a user may select the identity-as-collateral icon for a contact to view all recent interactions, at 140 (FIG. 22).

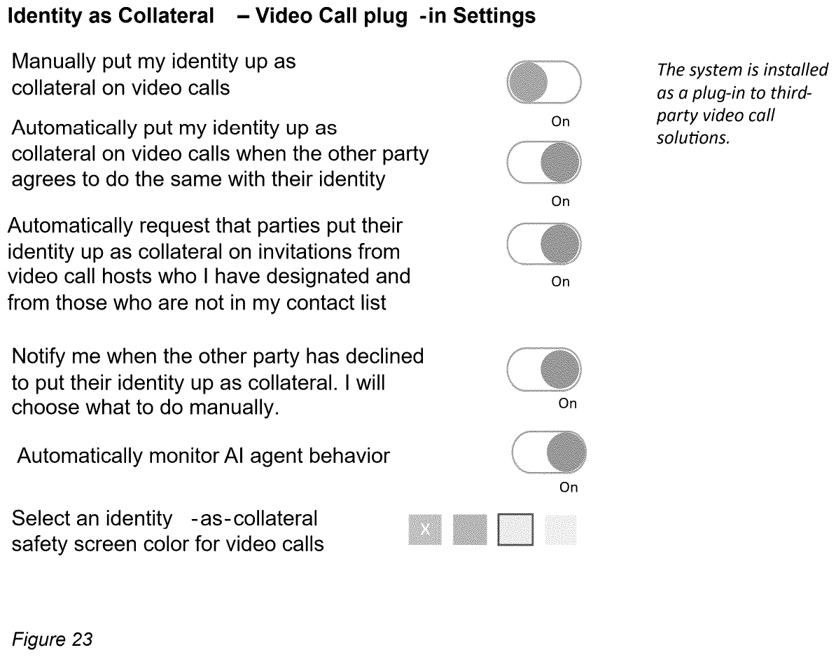

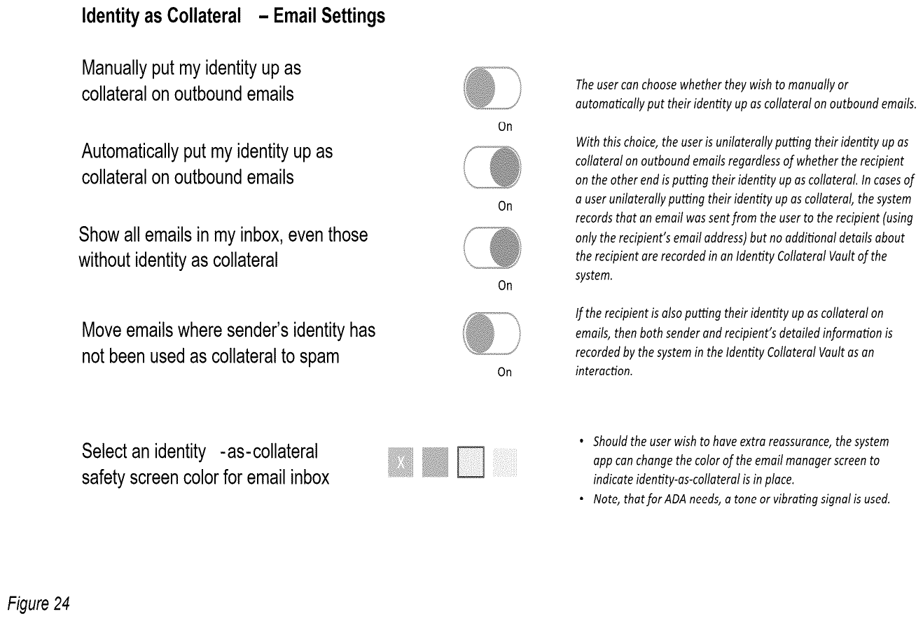

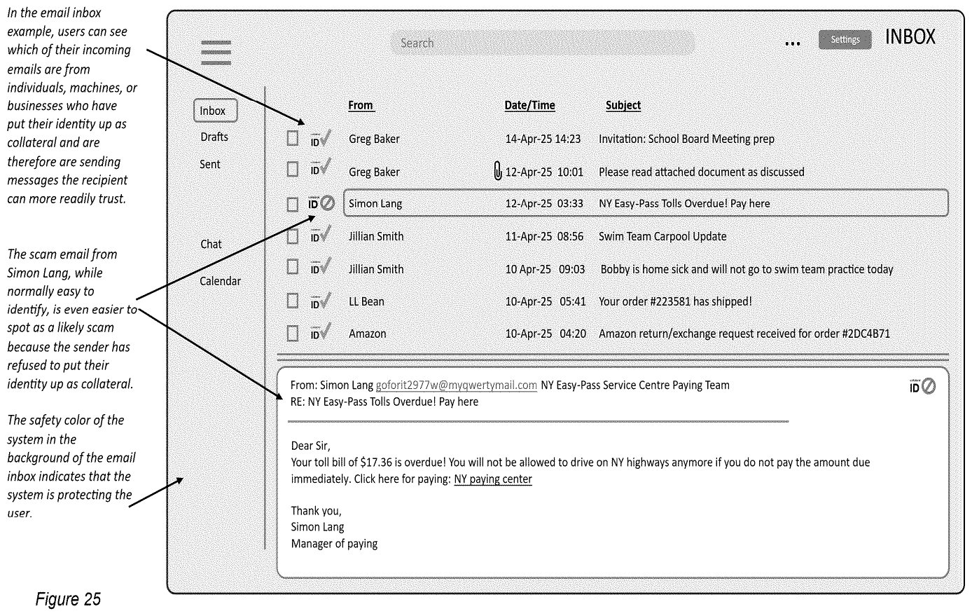

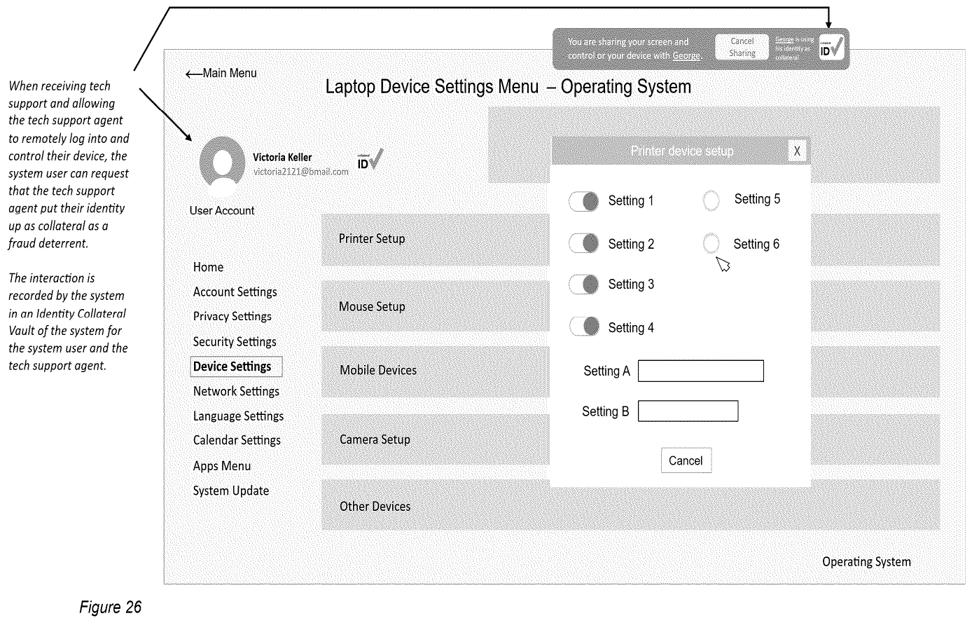

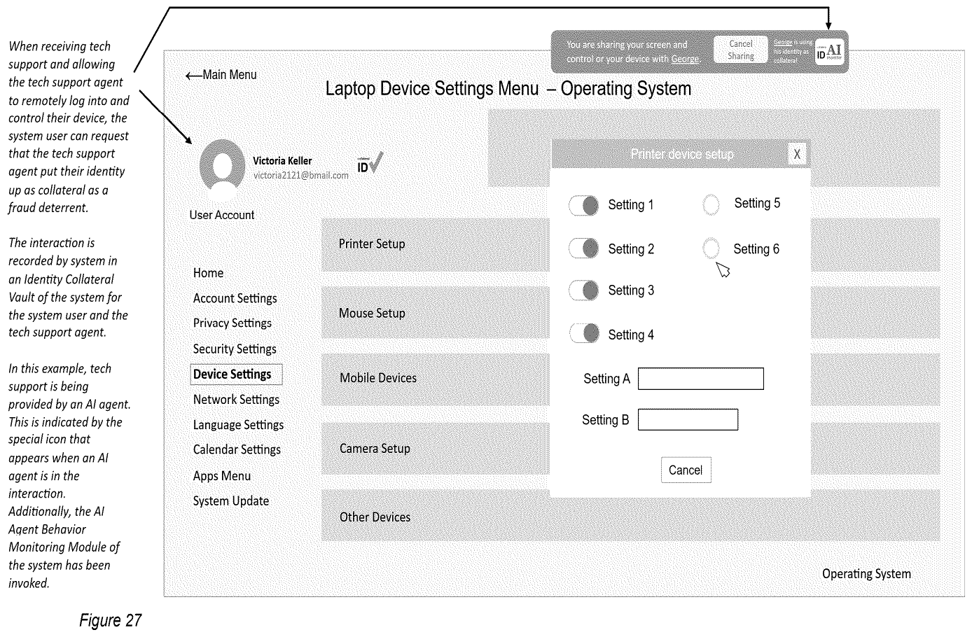

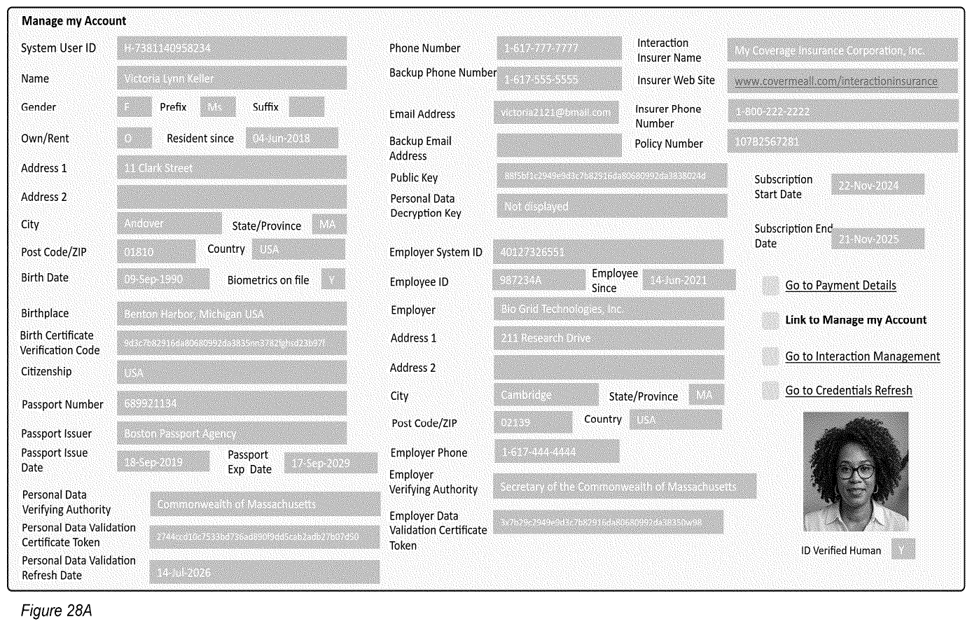

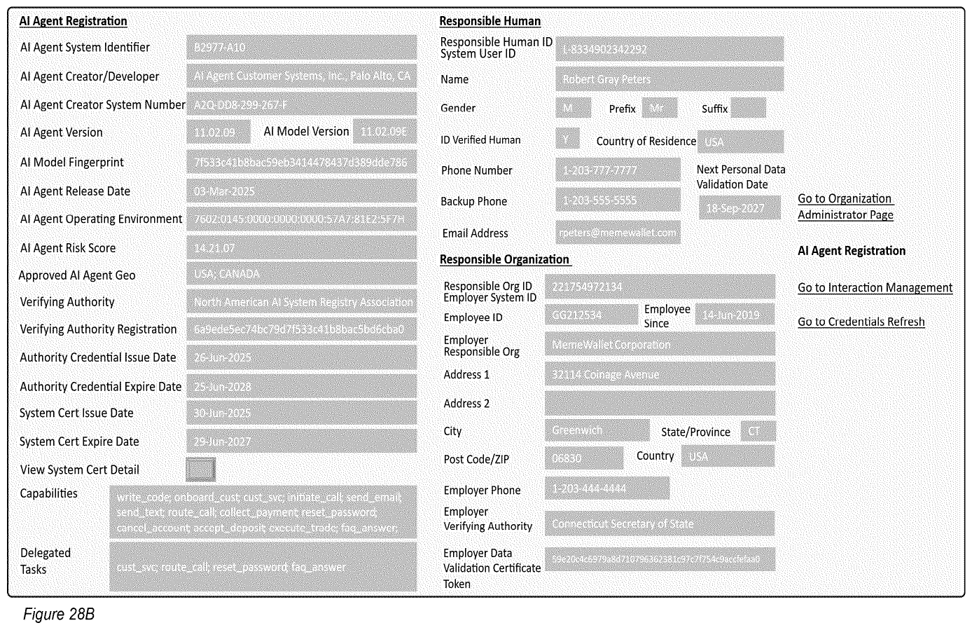

An exemplary set of settings for video conferencing is shown in FIG. 23. Exemplary settings for email interactions are shown in FIGS. 24 and 25. An exemplary embodiment in the form of a screen sharing app for remote desktop human and AI agent tech support is shown in FIGS. 26 & 27, respectively. An exemplary individual system user account management screen useful in any of the aforementioned embodiments is shown in FIG. 28A.

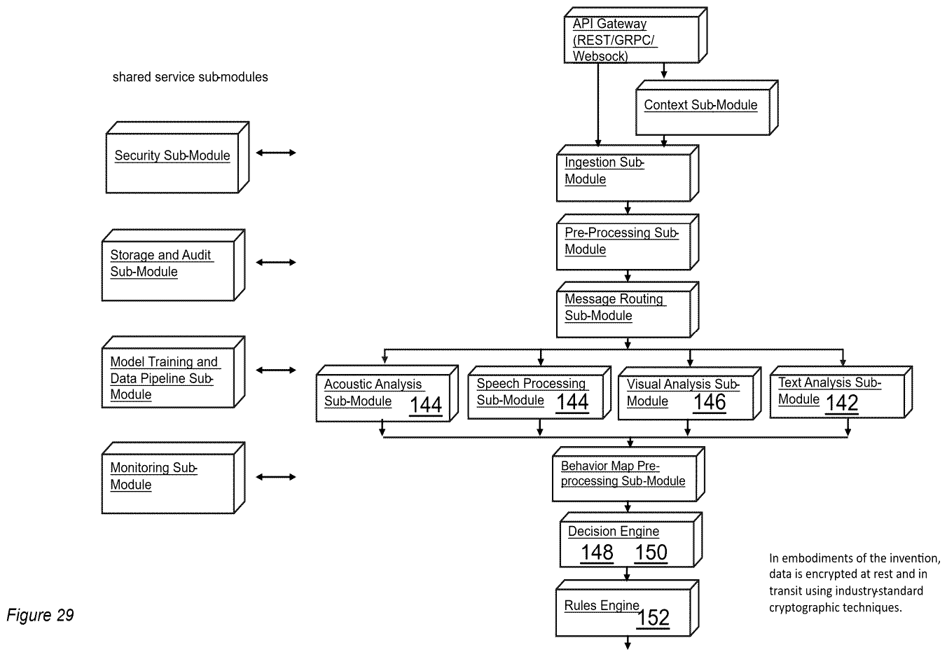

FIG. 29 is a functional block diagram of an embodiment of the present invention which includes an AI agent behavioral monitoring module. As shown, the solution monitors text, audio, and video at 142, 144 and 146, respectively, to integrate signals and generate scores indicative of behavior alignment 148, 150, which are compared with rules for behavior at 152. Results of this comparison are used to help determine whether the AI agent is behaving properly.

To summarize the foregoing, it should be recognized that the various embodiments of the present invention include the following elements/provisions.

### General

Users provide their personal information and verified digital identity to the system embodied as an application workflow when they sign up for the system using a KYC (Know Your Customer) process.
Users can opt-in to interaction insurance coverage for interactions where each party provides their identity as collateral using the system. The insurance is provided/underwritten by participating insurers.
With each interaction, the user of the system can decide that they wish to offer their identity as collateral against fraud in that interaction and can ask the other parties in the interaction to do the same.
The system securely stores the details of the interaction and the parties who participated in it along with their verified personal details for a defined period of time (e.g., up to 18 months) following the interaction.
In cases of fraud the system will respond to a subpoena from law enforcement, decrypt and release the required identifying information of interaction participants.
The risk of being discovered and prosecuted is a deterrent to fraud. The willingness to put one's identity up as collateral is a reassurance to the other participants in an interaction.
Interactions for which identities may be put up as collateral are human-to-human, human-to-business, human-to-machine, business-to-machine, and machine-to-machine.

### KYC Functions

Authenticate an individual human's digital identity using official digital Identity Validation Providers (typically governments) in order to onboard the user to the system.
Authenticate a business/organization's existence/identity with official Identity Validation Providers (typically governments) when onboarding businesses/organizations and their employees as system users.
Validate an individual human as being an employee of a business/organization that has been authenticated and on-boarded by the system.
Validate an AI agent and its Responsible Human and Responsible Organization when being onboarded to the system (via e.g., governments, other Identity Validation Providers, directly with the system). Provide a certification to be used as authentication of an AI agent when it is interacting with system users.
Capture and refresh verified personal information (e.g. name, DOB, residence locations, time at residence) from verified digital Identity Validation Providers for individual humans as part of the authentication and onboarding process.
Store credentials associated with the verification of the individual's identity for repeat use, audits/reference.
Store personal data from that authenticated individual as collateral against fraud for each interaction in an Identity Collateral Vault of the system.

### Privacy/Security

Data encrypted at rest and in motion, including personal data and interactions stored in an Identity Collateral Vault of the system. User authentication via 2FA and biometrics.
Interaction token numbering system for each logged interaction and designed to protect the parties to an interaction from being linked or associated with one another by unauthorized parties.
Use of a biometric token to protect photos and other biometric data from being directly accessed. Use of birth certificate and a liveness test to ensure a human is human and is alive.

### Interaction Insurance Offering

Offer interaction insurance to system users to insure against fraudulent interactions when each party to an interaction puts their identity up as collateral.
Ability to track interaction outcomes and put those outcomes back into the pool of interaction data for insurance underwriting.
Provide a dynamic pool of underwriting data to insurers wishing to provide interaction insurance to individuals, businesses/organizations, and/AI agent owners/controllers (Responsible Humans/Responsible Organizations).
Functions in the system app for interaction insurance claim underwriting, premium payment collection, logging, review and claim payout processes.

### Application Features

Smart phone app, web app, smart tablet app, providing a user interface designed for user KYC, user onboarding, account management, interaction insurance policy management, payment collection, app settings and to control the use of the identity-as-collateral service with each interaction across devices where the app, as an embodiment of the invention, is installed.
Examples of devices/channels available for interactions where identity can be used as collateral in the system: Phone (voice) calls, video calls, text messages, emails, tech support agent screen-sharing, social media posts. Some embodiments use a secure API to enable the solution to be embedded as a plug-in to existing phone, video call, email, social media, and tech support agent screen-sharing software.
Users can decide to automatically or manually offer their identity as collateral as part of each interaction for which they use the system.
Users can either automatically or manually request that their counterparts provide their identity as collateral before commencing an interaction.
Users are authenticated via biometrics or 2FA for each interaction.
Users can invoke an AI Agent Behavior Monitoring Module of the system to conduct real-time monitoring of an AI agent's behavior in interactions. The module builds an AI Agent Risk Score and warns the user when an AI agent's behavior is overstepping the AI agent's delegated authority. The system user has the option to shut down the interaction.
Businesses can use the identity validation features of the system to authenticate their customers using system credentials and a secure API embedded in the business's own customer service/order management platform.
The system provides a smart contract editor/manager module which allows businesses or individuals to propose terms of a commercial agreement to other businesses or individuals, negotiate versions of those terms with version tracking, sign on to those terms and rely on digital identity as one of the forms of collateral (against fraud) for the contracted obligation.

### Administrative Backend Functions

Securely log user interactions and store them for a defined period of time known as an Identity Collateral Period (e.g., 18 months) in an Identity Collateral Vault of the system.
Manage and purge interactions that have reached the end of their Identity Collateral Period (e.g., 18 months) unless ordered by a court to extend the storage duration.
Securely decrypt and deliver personal information which was stored as collateral for an interaction to law enforcement based on a subpoena in support of a fraud investigation and/or prosecution.
In some embodiments, two distinct computing domains are used to separate the system supporting user on-boarding, end-user interfaces, interactions, and capturing identity as collateral (Encrypt Service) from the system handling the decryption of personal data in response to a law enforcement subpoena when fraud is suspected in an interaction (Decrypt Service).

### Persona Handling

A plurality of user roles interact with, or are key elements of embodiments of the system. The user roles and functions described herein are exemplary and do not limit the manner in which the system may be accessed or utilized.

### Interaction Participant—Individual System User

An individual not affiliated with an organization (for the purposes of this particular embodiment of the invention).
Uses the system to initiate conversations and prove that they have put their identity up as collateral against fraudulent interactions.
Relies on the system for themselves when someone initiates contact with them, for safety, integrity, community, and ease of use.
Wishes to receive conversations from those who can prove their identity and have put up their identity as collateral against fraudulent interactions; to have confidence in receiving calls, especially from individuals who they are not regularly in contact with. They also want to validate individuals they converse with regularly out of concern that they could be “spoofed” by some mechanism for fraudulent purposes.

### Interaction Participant—Organization

An individual affiliated with an organization (for the purposes of this embodiment of the invention).
The individual's affiliated organization is motivated to have this individual (employee) prove that they have put up their identity as collateral against fraudulent interactions in order to demonstrate to the receiver that the caller is legitimately from the organization stated.
The individual's affiliated organization is also motivated to have confidence that conversations received from others which contain sensitive information may proceed because all parties have put up their identities as collateral.
Each person, whether as an individual or as an employee of an organization, must have an individual account in the system and have put their identity up as collateral before they can be added to an organization's account in the system. They may have established their individual account with the system before they join an organization or are mandated to establish a personal account in the system after they join an organization so they can participate in the organization's use of the system.

### Interaction Participant—AI Agent

An AI agent is linked with a Responsible Human in the system. In most cases the AI agent and the Responsible Human are also linked to a Responsible Organization.
By putting their identities up as collateral, the AI agent, the Responsible Human, and the Responsible Organization are reinforcing that the AI agent (its conversations and behaviors) can be trusted. If not, the Responsible Human and Responsible Organization will take full accountability for the outcomes.
The AI agent persona, established in the system during on-boarding, is treated as an extension of the human who is responsible for it.

### Organization Administrator

An individual or group of individuals responsible for administering the organization's presence on the system/platform, i.e. the organization administrators: setup, configure, monitor and operate the platform from the perspective of the organization.
This persona onboards and removes organization employees and AI agents as users of the system on behalf of the organization.

### System Administrator

An individual or group of individuals responsible for administering (operating) the entire system i.e. this persona sets up organizations on the platform, configures, monitors and operates the platform. A system administrator is typically an employee of the provider of the system.

### System Identity Collateral Vault Administrator

An individual or group of individuals responsible for securely administering an Identity Collateral Vault within the system.

### AI Handling in the System

### AI Agent Authority and AI Agent Certificate (Cert)

Upon registration of an AI agent with the system, the Responsible Human who is registered with the AI agent receives an AI Agent Certificate (similar to an SSL certificate) that has, encoded in it, all the information used to register the AI agent, as well as an indication that the certificate has been signed by an AI Agent Authority. This is a public key infrastructure (PKI) system for registering and authenticating AI agents with human accountability, permissions scoping, and identity. It is a trust framework for AI agents with a built-in chain of responsibility tied to identities that have been put up as collateral. In particular embodiments, the generated certificate contains: AI agent identifiers, capabilities, and platform scope; a signature from the AI Agent Authority; and a public key for the AI agent (and the Responsible Human). (see Table 2 Exemplary Payload Data Elements for an AI Agent Cert)

This certificate is installed or associated with the AI instance when it operates on the chosen platform. When the AI agent interacts with a human or other AI, the platform validates the cert, verifies it was issued by a trusted authority, and knows who to attribute actions to. This blends identity, permissions, and accountability into a single artifact—the AI Agent Certificate.

These functions enable: traceability—every AI action can be traced to a Responsible Human; accountability—platforms can enforce rules by revoking certificates or banning bad actors, because the AI agent and Responsible Human have put their identities up as collateral; permission control—capabilities can be bounded and enforced via signed claims in the cert; and scalability—like SSL certs, this function may be used across platforms.

### Additional Functions Implemented by the AI Agent Authority:

In some embodiments the AI agent itself need not sign messages with its own private key, but presents the certificate (like a bearer token).
Platform Enforcement: The hosting platform is responsible for verifying and enforcing the AI agent's capability restrictions. This is similar to a browser enforcing SSL claims.
   Revocation: The platform maintains a CRL (Certificate Revocation List) or uses OCSP (Online Certificate Status Protocol) validation.
   AI Agent Capabilities: stored as machine-readable semantic tags processed by the system include: e.g., write_code, onboard_cust, initiate_call, send_email, collect_payment, cancel_account, while also incorporating more specific capabilities such as ability to use particular APIs, rate limits, and data access scopes.

In particular embodiments, an external platform (e.g. a commercial artificial intelligence provider):
Validates the cert on AI startup or API request;
Limits the AI's actions based on capabilities in the cert;
Logs activity with attribution to the registered Responsible Human owner; and
The AI agent signs requests or responses using a private key tied to the cert, making them cryptographically attributable.

Those skilled in the art will recognize that the foregoing aspects of AI Agent Authority and AI Agent Certificates may be practiced by modifying the following conventional technologies in accordance with the teachings herein:
SSL/TLS certs: Auth for domains with CA trust chains;
OAuth2 JWTs: Auth+scopes with signed claims;
Code signing certs: Software authenticity and developer attribution; and
Delegation models such as AWS IAM Roles or GCP Service Accounts.

The following Table 1 includes a list of system components of a representative AI Agent Authority Module of the system

TABLE 1
System Components of the AI Agent Authority Module

| Component | Description |
|---|---|
| User Portal/Frontend | UI for registering AI agents, viewing |
| | issued certs, and managing keys. |
| Registration Service | Handles user identity, AI agent registration, |
| | validation, and initiates cert issuance. |
| Certificate Authority | Issues and signs certificates. Manages the |
| (CA) Service | root/intermediate keys. |
| Cert Store/Registry | Database or key-value store for issued certs |
| | (and optional revocation list). |
| Platform Verifier | Logic on downstream AI platforms (e.g., |
| | ChatGPT plugin) that verifies certs. |
| Key Generation | If the AI agent needs its own keypair (e.g. |
| Service | for signing messages). |

### Certificate Authority Module

This module of the system issues, signs, revokes and validates certificates (including AI Agent Certificates). It also manages root keys, rotation policies and can expose cert validation services via API. Note that this is not the module that monitors AI agent behavior or security.

Core components of the Certificate Authority Module of the system include:
Issuer sub-module which generates the certificate based on inputs from among others, an Organization Administrator and a Responsible Human;
Revoker sub-module which manages and executes revocation requests;
Validator API which manages messaging with other platforms regarding the validation of a certificate;
Key Management sub-module which manages encryption and facilitates authentication;
Audit Logging sub-module which captures detailed user and system-related activities related to handing of AI agent certificates; and
Admin interface which allows for monitoring and analyzing system performance and adjusting system parameters.

### AI Agent Certificate Payload Detail

In particular embodiments, certs issued by the system and assigned to an AI agent permitting it to put its identity up as collateral and to interact with other system users (humans or other machines) across communications channels (phone, text/SMS, video calls, email, social media, tech support) have the following characteristics;
The contents of the cert payload connect the AI agent to a Responsible Human and Responsible Organization;
The cert, and thus the AI agent's validity, is revocable. Revocability allows the system as a whole to demonstrate trust because the AI agent can lose its validity based on predetermined criteria; and
The cert payload data elements enable tracking and controls on a broad cross section of AI agent characteristics and behaviors.

TABLE 2
Exemplary Payload Data Elements for an AI Agent Cert
Data Elements

AI/AI Agent System Identifier - number assigned by the system to the AI agent when it
is on-boarded. This is the equivalent of a Responsible Human Identifier but, in this
case, it confirms that the AI agent's identity has been put up as collateral against
fraudulent interactions. This identifier is linked to the AI Agent Cert issued by the
system.
AI Agent Creator System Number - the AI owner/developer's own identifier assigned
to the AI agent.
AI Agent Creator/Developer - details about the provenance of the AI agent. This is
different from the Responsible Organization Identifier. For example, the AI agent may
have been created/developed by an AI agent provider but is being used by a financial
institution on the financial institution's technical infrastructure for customer service.
AI Agent Version - software version maintained by the AI Agent Creator/Developer
AI Model Version - this is a separate version number for the AI model as compared to
versioning for the rest of the AI agent code base.
AI Model Fingerprint - a token based on unique traits the AI agent model exhibits
from its training and observed behavior. This fingerprint is observed, generated, and
refined by the system during the AI agent's interactions with system users.
AI Agent Release Date - indicates when the AI agent first went into service. Is used to
control for an AI agent being put into service without a burn-in period.
AI Agent Operating Environment - IP addresses and other machine-readable
expressions of the technical environment in which the AI agent is permitted to run.
AI Agent Risk Score - assigned by the system to the AI agent based on an assessment
module of the system using the parameters of the system AI Agent Certificate and the
real-time behavior of the AI agent. An exemplary set of input parameters for the
system assessment module to calculate the AI Agent's Risk Score and captured in
machine-readable form are: the AI agent's Model Fingerprint, the AI agent's
Capabilities compared to its Delegated Tasks, maturity of the AI agent code, breadth
of the AI agent's technical Operating Environment, the AI agent's Approved Customer
Geography, and previous interaction outcomes for the AI agent provided by the AI
Agent Behavior Monitoring Module of the system. In some embodiments, the AI
Agent Risk Score is updated in real-time based on current AI agent interaction
behavior. In some embodiments, machine-readable inputs are provided by third-
party AI agent risk services.
A plurality of probability scores and composite probability scores are calculated by a
scoring engine of the system based on the input parameters above.
Exemplary uses of the AI Agent Risk Scores: the system determines when an AI Agent
Cert should be revoked and/or an insurance provider uses them as inputs into the
insurance pricing and underwriting process for AI agent interaction insurance.
AI Agent Capabilities - list of the AI agent's universe of capabilities whether delegated
or not, for specific use in conjunction with the system. This list is expressed in a
machine-readable configuration language and is used by the system to understand
the potential risks of the AI agent behaving outside of its Delegated Tasks. Example:
the AI agent may be capable of writing code “write_code” but its Delegated Tasks
indicate that it is not allowed to write code when interacting with the system
platform.
In some embodiments, as illustrated at FIG. 14B, these capabilities are displayed in a
human readable representation on the system app GUI for the system user to review
as part of an interaction with an AI agent.
Delegated Tasks - list of tasks and capabilities that the AI agent is specifically
permitted to do when interacting with the system. This list is expressed in machine-
readable configuration language.
In some embodiments, as illustrated at FIG. 14B, these capabilities are displayed in a
human readable representation on the system app GUI for the system user to review
as part of an interaction with an AI agent.
Approved AI Agent Geography - The AI agent is approved to interact with individuals
who are domiciled or present in these geographies.
Responsible Human System Identifier - this is the link to the human user of the
system who has also put their identity up as collateral to take responsibility for the AI
agent's behavior. This is required before any AI agent may interact with the system.
Responsible Organization System Identifier: This is the business owner of the AI agent
and where the Responsible Human is employed. This identifier is not always
populated since AI agents do not require affiliation with a business, only with a
human to receive a system cert.
Verifying Authority - which governing body, or other entity, is providing verification
that the AI agent is approved/licensed. (e.g. a self-regulatory industry association, the
European Commission)
Verifying Authority Registration Number - reference/license number assigned to the
AI agent by the Verifying Authority.
Verifying Authority Registration Certificate - reference to the Verifying Authority's
certificate for this AI agent.
Verifying Authority Credential Issue Date and Verifying Authority Credential
Expiration Date - indicators of the validity of the credentials issued by the Verifying
Authority.
System Cert Issue Date and System Cert Expire Date - these are the dates when the
AI agent was first approved for access to the system and when that approval, or cert,
expires and must be renewed.

### AI Agent Behavior Monitoring Module

AI agents may be created on platforms and systems as they are currently, e.g., on a generative AI provider's platform. In creating the AI agent, it is developed and trained in a conventional manner, while also embedding in the AI platform an AI Agent Cert acquired from the system as an embodiment of the present invention. The AI agent operates in a substantially conventional manner. Except that when conversing with a user, it presents the AI Agent Cert acquired from the system. This allows the user to:
confirm that the AI agent is who it says it is;
confirm that the AI agent has been proven to be attributable to a human creator of the AI agent and to a Responsible Human and optionally, a Responsible Organization; and
view the capabilities of the AI agent.

In some embodiments, a generative AI provider's platform may use the AI Agent Behavior Monitoring Module of the system prior to delivering content to the user (content such as text, audio/voice, video) by sending the content first to the AI Agent Behavior Monitoring Module of the system for vetting and approval using the following example:
1. The AI agent would like to communicate something to the user:
   the AI agent is triggered to communicate with the user, such as:
      a timed condition: a system has told the AI agent to communicate with a user to remind them they have an appointment tomorrow; and
      A response: the AI agent is conversing with a user and the previous prompt/text that the user entered requires that the AI agent respond.
2. The external AI agent platform transmits the content it would like to deliver to the user to the AI Agent Behavior Monitoring Module. This includes the actual form of the transmission (e.g., text/audio/video).
3. The AI Agent Behavior Monitoring Module evaluates the content for compliance with the stated capabilities of the AI agent (in the cert).
4. If the AI Agent Behavior Monitoring Module of the system determines that the communication content is compliant with the stated capabilities, the AI Agent Behavior Monitoring Module of the system responds to the external AI agent platform with a positive/success indicator and also a certificate that is proof that the exact communication has been viewed by the AI Agent Behavior Monitoring Module and is compliant with the stated capabilities.
5. If the AI Agent Behavior Monitoring Module determines that the communication content is not compliant with the AI agent's stated capabilities, it responds with a negative/failure indicator.
6. The AI agent behavior monitoring module warns the system user that the AI agent is misbehaving, giving the user the option to terminate the interaction.
7. The external AI agent platform delivers the content that it vetted with the AI agent behavior monitoring module to the user along with the proof that it was vetted by the AI Agent Behavior Monitoring Module of the system. The user (i.e. the client that the user is using) is able to view the proof that the communication was vetted by the AI Agent Behavior Monitoring Module, and the UI of that client reflects the proof with an Identity-as-collateral Icon and an Interaction Token.
   This substantially continuous handshaking (i.e., delivering the proof that the communication was vetted) provides the system user with ongoing assurance of compliance of the conversation.

In some embodiments of the invention, the AI Agent behavior Monitoring Module may also be used by the AI agent platform after communicating to the user, in this scenario the AI Agent Behavior Monitoring Module allows the external AI gent platform to keep logs of communication with users and have awareness of the compliance of that communication.

### Client-Side Monitoring by the AI Agent Behavior Monitoring Module of the System:

1. The AI Agent Behavior Monitoring Module is also used by the user's client software, and in some embodiments, the system itself. In this application, the AI Agent Behavior Monitoring Module monitors incoming communication from the AI agent for compliance with the stated capabilities (within the cert).
2. The AI Agent Behavior Monitoring Module may also be used to evaluate communication with another human, this could be another system user or, in some embodiments, any user of a communications platform.

In particular embodiments, the AI Agent Behavior Monitoring Module is provided as a service of the system platform for use by AI agent platforms or other potential clients. In these embodiments, the AI Agent Behavior Monitoring Module includes:
Vetting/monitoring communication between users of the system (AI agents or humans); and
Recording of communications (for compliance reasons); and
Warning users when the AI agent has overstepped its behavioral boundaries.

The AI Agent Behavior Monitoring Module vets/monitors communication in a variety of mediums such as text/audio/video. The system judges compliance of communication such as facial expressions, tone, improper language, disallowed requests such as a request for a credit card number or other compliance with a capability allowed or disallowed in the cert.

### Example Components of the AI Agent Behavior Monitoring Module of the System:

Referring back to FIG. 29, in some embodiments, the system is provided for receiving, processing, and evaluating multiple distinct types of communication/data including text, audio, video, and contextual data.

Ingestion sub-module—an ingestion sub-module is configured to receive input data from one or more client devices, applications, or external systems via one or more communication interfaces. In certain embodiments, the ingestion sub-module includes one or more application programming interfaces, which may support synchronous and asynchronous communication protocols. The ingestion sub-module may receive one or more data types, including AI Agent Cert parameters and other textual data, audio data, video data, and metadata associated with a session, user, device, transaction, or computing environment.

Context sub-module—A Context sub-module, which in certain embodiments, may monitor a Model Context Protocol or other messaging layers, provides awareness of machine-to-machine interactions and provides situational awareness of events occurring simultaneously to the primary AI agent interactions being monitored by the AI Agent Behavior Monitoring Module of the system. The Context sub-module aggregates and prioritizes variables from external information sources and/or oracles on e.g., breaking news, stock prices, commodity prices, weather, traffic data, flight delays; and sensor data from e.g., burglar and fire alarm systems, temperature sensors, water sensors, manufacturing sensors; and e.g., vehicle sensors (autonomous or otherwise) for geolocation, speed, direction of travel, auto make/VIN, engine/motor diagnostics, auto service records, auto crash history, passengers present. The Context sub-module feeds this data to the ingestion sub-module to be included in evaluating the behavior and consequences of that behavior of a particular AI agent.

Pre-processing sub-module—A Pre-processing sub-module is configured to perform normalization and enhancement operations upon received media inputs. In some embodiments, the Preprocessing sub-module performs file type normalization, codec conversion, signal enhancement, noise reduction, and silence trimming. For video data, preprocessing may include adjusting video frames to a consistent frame rate or image stabilization. For audio data, preprocessing may include segmentation into phrases for downstream processing.

Message Routing sub-module—the received data is transmitted to a message routing and queuing sub-module configured to buffer, manage, and route data between various system components. The Message Routing sub-module may be configured to distinguish between streaming data requiring real-time or near-real-time processing, and batch data intended for offline or deeper analysis.

Behavior Map Pre-processing sub-module—this sub-module analyzes the AI Agent Cert payload data received via the Ingestion sub-module in order to generate features which define an acceptable behavior map for an AI agent. These features are used as inputs in the Decision and Rules Engines to determine when an AI agent's behavior breaches the boundaries of its behavior map.

Speech Processing sub-module—a Speech Processing sub-module is configured to convert audio data (including from video) into textual representations. In certain embodiments, the Speech Processing sub-module implements one or more speech recognition models to generate transcriptions in real time or near-real time.

Text Analysis sub-module—A Text Analysis sub-module is configured to process textual data obtained directly from inputs or generated by the Speech Processing sub-module. In some embodiments, the Text Analysis sub-module performs one or more natural language processing operations, including but not limited to normalization, tokenization, syntactic parsing, semantic analysis, and classification. The process may identify attributes such as intent, tone, emotional state, category, or thematic content, using one or more trained machine learning or rules-based models.

Acoustic Analysis sub-module—An Acoustic Analysis sub-module is configured to extract additional features from audio data, including but not limited to pitch, tone, energy, speaking rate, and pause duration. The Acoustic Analysis sub-module may apply one or more classification models to identify attributes such as emotional state, stress level, deception likelihood, or other behavioral indicators.

Visual Analysis sub-module—a Visual Analysis sub-module is configured to analyze image and video data. In certain embodiments, the Visual Analysis sub-module performs face detection and tracking, facial expression recognition, pose estimation including gesture analysis, and object detection. In some embodiments, the Visual Analysis sub-module may further detect subtle facial movements indicative of cognitive or emotional states.

Decision Engine—the outputs of the Behavior Map Pre-processing sub-module, Text Analysis sub-module, Acoustic Analysis sub-module, and Visual Analysis sub-module are provided to a Decision Engine. The Decision Engine is configured to temporally align and integrate signals from multiple distinct communication types. In certain embodiments, rules-based logic, in combination with one or more machine learning models to generate scores indicative of a condition, behavior, or policy alignment.

Rules Engine—the Rules Engine is configured to apply one or more policies to the outputs of the Decision Engine. These policies are adjusted based on inputs from the Behavior Map Pre-processing sub-module in order to align rules with the specific AI Agent Certs. In some embodiments, the Rules Engine determines whether certain thresholds, conditions, or criteria have been met, and may trigger subsequent actions, such as recommending that the system user should terminate the interaction.

Storage and Audit Sub-module—the system further includes a Storage and Audit sub-module along with secure repositories which retain input data, intermediate results, system outputs, and system audit logs. In some embodiments, the storage and audit repositories are configured to maintain tamper-evident records. In some embodiments the repositories are configured to delete text, audio, and video content if an interaction ends with no behavioral breaches of the AI Agent's Cert.

Model Training and Data Pipeline sub-module—a Model Training and Data Pipeline sub-module supports training, validation, and updating of one or more machine learning models used by the system. Sources of input data may include data from the storage repositories. This sub-module augments data, generates features, and updates deployed models to improve system behavior monitoring effectiveness over time.

Monitoring sub-module—a monitoring sub-module tracks the performance of the AI Agent Behavior Monitoring Module end-to-end. This includes but is not limited to system-health, performance metrics, and latency. The outputs of this function may be dashboards, logs, alerts and a UI for human monitoring.

Security sub-module—a Security sub-module enforces authentication, authorization, and encryption for the AI Agent Behavior Monitoring Module within the system as well as access to that function from outside platforms which occurs, in some embodiments, via secure API.

A functional block diagram of a representative embodiment of a system including the aforementioned AI Agent Behavioral Monitoring Module is shown in FIG. 29.

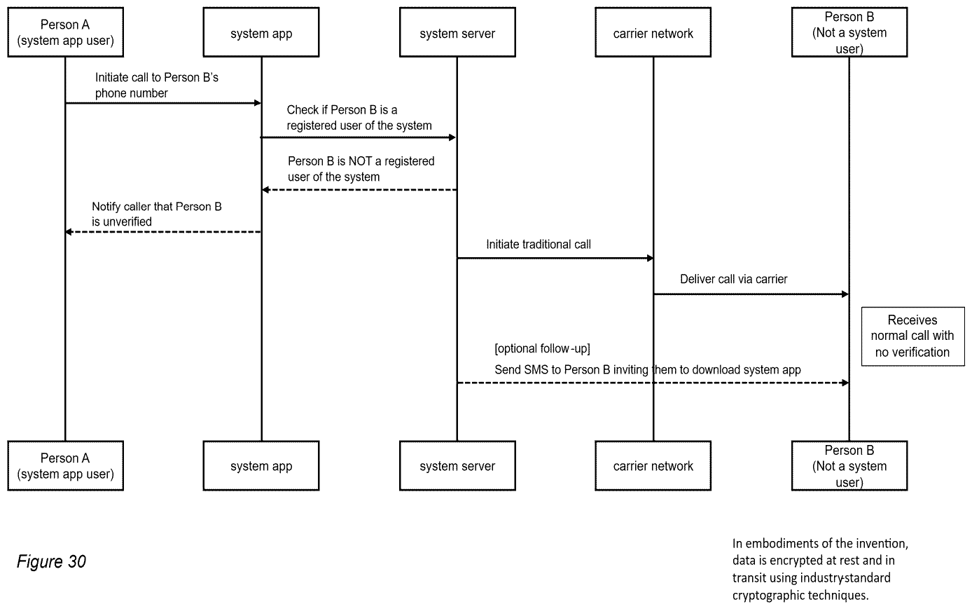

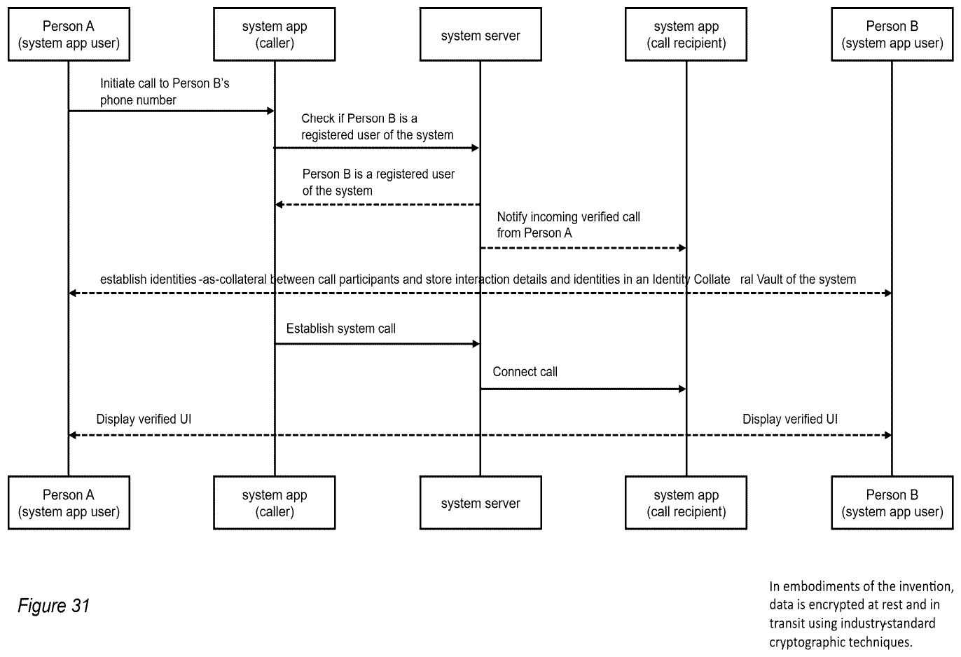

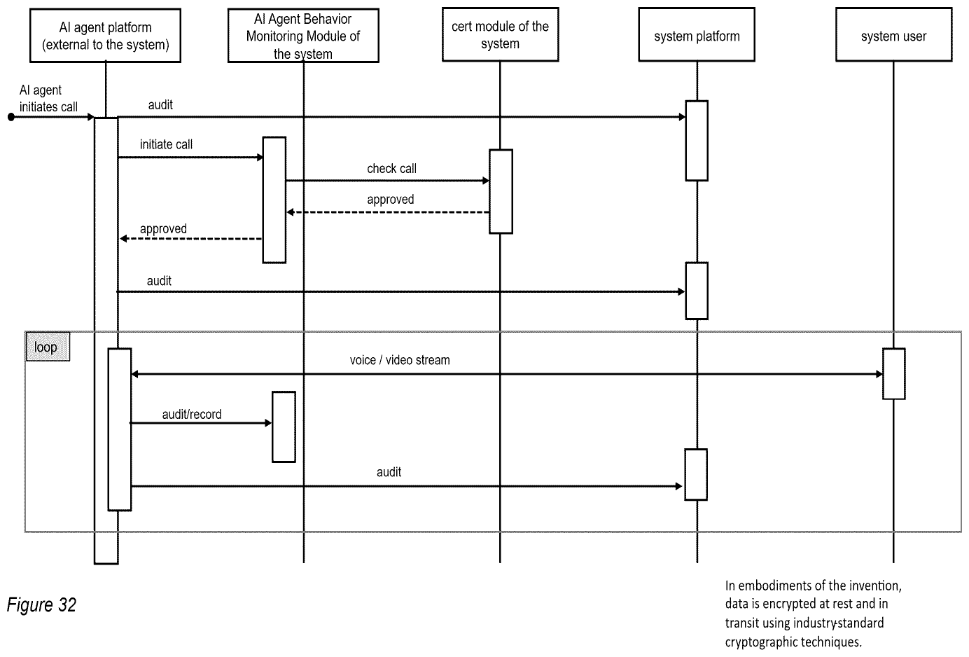

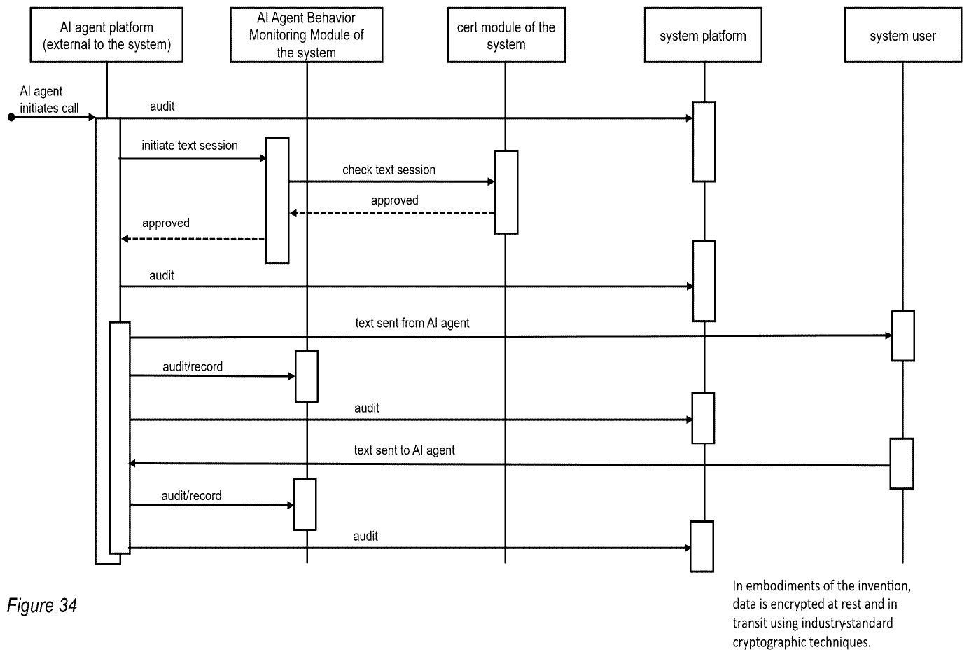

Turning now to FIGS. 30-34 user flows and functionality associated with particular embodiments of the present invention are shown and described. FIG. 30 details video/voice calls in Use Case 1: from a verified caller to an unregistered recipient. FIG. 31 details video/voice calls in Use Case 2: from a verified caller to a verified recipient. FIGS. 32 & 33 detail AI agent flow for AI agent monitoring and communication. FIG. 34 details messenger/text/chat flow.

In various embodiments, an initial step involves user registration:

New individual user of the system, as detailed in FIG. 1

The individual user registration process may be executed using an end-user device. In some embodiments the system app presents a user registration interface on the display of a user's mobile device. The registration interface program guides the user through a series of steps to capture user registration data, biometrics, liveness test, and identity verification data; and

In some embodiments, the system app executes a third-party authentication request to confirm the new user's identity via an existing user account at that third-party provider; and

In some embodiments, the registration program receives the user registration inputs and user identity verification data and transmits this information to a backend Identity Verification Module of the system to evaluate the data for authenticity and completeness. The backend Identity Verification Module transmits this information securely to a plurality of third-party Identity Validation Providers for verification and to receive supplemental identity profile data. Upon confirmation, the back-end system creates/updates the user's unique system profile with the user's biometric token and authenticated data; and

The registration process, the data captured, the back-end identity verification step, and secure storage process, enable the system to be used, in some embodiments, for a combination of biometric verification, secure communications, and staking the user's verified identity data as collateral against the occurrence of fraud in that user's interactions.

New organization as a user of the system and new individual as user of the system on behalf of the organization.

In some embodiments of the invention, the registration of a new organization whose employees are to be users of the system by putting their identities up as collateral in business-to-business and business-to-consumer interactions on behalf of that organization, is carried out in two steps.

In Step 1, a System Administrator, employed by the provider of the system, accesses a secure System Administrator application interface. The application interface, using a display on an end-user device, guides the System Administrator through a series of steps to enter the registration information of the applicant organization. The registration data for the organization includes at least one organization employee who is already a verified individual user of the system. This individual serves as the Organization's Administrator. The baseline registration and Organization Administrator data is then transmitted to a backend Identity Verification Module of the system to evaluate the data for authenticity and completeness. The backend Identity Verification Module transmits this information about the organization securely to a plurality of third-party Identity Validation Providers for verification and to receive supplemental identity profile data. Upon receipt of a confirmation message and supplemental data from the third-party systems, the back-end Identity Verification Module of the system creates/updates and securely stores the organization's unique system profile with the authenticated data; and

In some embodiments, in Step 2 the Organization Administrator then receives an email invitation and link to access a secure Organization Administrator interface of the system. The Organization Administrator completes the setup of their Organization Administrator user in the system using the Organization Administrator interface displayed on an end-user device. Upon completion of this step, this data is transmitted to the backend Identity Verification Module of the system. The verified identities of the organization, the Organization Administrator, and the Organization Administrator's individual system user (including biometrics) are then linked by the Identity Verification Module of the system and stored securely by the system.

In some embodiments of the invention, a link is established via secure API between the backend Identity Verification Module of the system and the organization's own IDP (identity provider) e.g., Microsoft Entra, Okta, or Oracle to be used by the system as a verification of employment step for managing system users who are employees at that organization.

The Organization Administrator may now use the Organization Administrator interface of the system and the secure API link between the system and the organization's IDP to register other employees of the organization as verified representatives of the organization in the system. Each employee is required to have an individual system user prior to becoming a system user linked to the organization. The backend Identity Verification Module of the system confirms the registered status of the individual, including a secure verification message exchange with the organization's IDP, in order to link the individual system user's identity to the organization's identity in the system. This link and the identity data collected is securely stored by the system. This individual is now permitted to use the system to put their identity up as collateral in business-to-business and business-to-consumer interactions on behalf of the organization.

### AI Agent Registration

In some embodiments, registration and permissioning of an AI agent on the system on behalf of an organization is carried out by the Organization's Administrator of the system.

The Organization Administrator accesses the Organization Administrator interface of the system using a display on an end-user device. The Organization Administrator is guided through the AI agent registration steps by an AI Agent Authority module of the system. An exemplary AI agent registration screen, useful in this embodiment is shown in FIG. 28B; and

In some embodiments, the Organization Administrator, prompted by the registration application, enters AI agent identity data as specified by the AI Agent Cert payload of the system, including AI agent behavior parameters (see Table 2). This includes capturing a Responsible Human who is a verified individual user of the system and is a verified employee of the organization. The Certificate Module of the system in conjunction with the AI Agent Authority Module of the system evaluates the data for authenticity and completeness. In some embodiments, the backend Identity Verification Module securely transmits this information about the organization and AI agent to a plurality of third-party Identity Validation Providers for verification and to receive supplemental identity profile data about the AI agent. Upon receipt of a confirmation message and supplemental data from the third-party systems, the backend Identity Verification Module of the system updates and securely stores the AI agent's unique system profile and its link to the Responsible Organization and Responsible Human with the authenticated data. The AI Agent Authority Module and Certificate Modules of the system then assign a cert for this AI agent.

The cert is transmitted securely to the Responsible Human and is deployed by the organization to its AI agent platform. The AI agent is now ready to put its identity, along with that of the Responsible Human and Responsible Organization, up as collateral against fraud in its machine-to-human and machine-to-machine interactions using the system.

The AI Agent Behavior Monitoring Module of the system uses the issued cert as an input in evaluating whether the AI agent is behaving within the bounds of its permitted behaviors during interactions with humans and machines.

### Video/Voice Calls

Turning now to FIG. 30, Use Case A: verified caller calling an unregistered recipient is shown and described.

Scenario: A user with the system app (Person A) calls someone who does not have the system app (Person B).

### Steps:

1. Person A opens the system app and initiates a call to Person B's phone number.
2. The system app sends a request to the system server to check if Person B's number is registered.
3. The server responds: Person B is not registered.
4. The system app notifies Person A: “This contact is not yet verified with the system.” Person A is now aware that Person B is not yet a user of the system and therefore Person B's identity cannot be put up as collateral for a call.
5. The server routes the call through the carrier network (PSTN-Public Switched Telephone Network), bypassing the identity-as-collateral functions of the system.
6. Person B receives a normal phone call.

Optional follow-up: the server or app sends an email or SMS invite to Person B to install the system app for future verified/identity-as-collateral communication using the system.

Turning now to FIG. 31, Use Case B: verified caller calling a verified recipient is shown and described.

Scenario: Both Person A and Person B have the system app, as an embodiment of the invention, installed on their devices.

### Steps:

1. Person A initiates a call through the system app using Person B's phone number.
2. The app checks with the system server: is this number registered?
3. The server confirms: Person B is a registered user of the system.
4. The server notifies both apps that verified communication is possible.
5. The server establishes a secure, app-to-app call via the system (not the carrier).
6. Person B receives the call within the system app, along with verification metadata (e.g., name, photo, ID status, age category).
7. Person A receives verification metadata from Person B (e.g., name, photo, ID status, age category).
8. Interaction details and identity-as-collateral data for Person A and Person B is captured in an Identity Collateral Vault of the system.

Elements regarding the conversation and placing identities up as collateral, call initiation and preferences.
Calls are initiated by first specifying the receiver, this is done via the phone number of the call receiver. A caller can have the following settings outcomes:
   Caller requires receiver to put their identity up as collateral.
      The platform ensures that the receiver is a system user.
         The receiver has configuration on regarding putting his identity up as collateral for callers.
         Exemplary options include:
         Always put identity up as collateral for callers.
         Put identity up as collateral for callers in my contacts list.
         Put my identity up as collateral for callers who are from a particular organization.
      The call is placed through the system.
   Caller is indifferent as to whether receiver has put their identity up as collateral.
      The platform checks if the receiver is on the system.
      The call is placed via the system if the receiver is on the system and is placed via PSTN if the receiver is not on the system.
   Receiver requires caller to put their identity up as collateral.
      The caller initiates the call (assuming they do this using the system platform), the system checks the identity-as-collateral settings for both the receiver and caller and concludes that the receiver will not take the call unless the caller puts their identity up as collateral.
         If the caller has not put their identity up as collateral, the system asks the caller to put their identity up as collateral in order to proceed with the call.
   Receiver does not require caller to put their identity up as collateral.
      Platform determines the best method of making the call (PSTN or the system phone app) and allows the call to proceed.

It should be recognized that any of the following conventional technologies used to make voice/video calls may be modified in accordance with the teachings herein, for use in various embodiments of the present invention:

TABLE 3
Technology used in the making of voice/video calls

| | Role in | |
|---|---|---|
| Technology | the scenario | Description |
| WebRTC (web real-time | Core media transport | Handles real-time audio/video |
| communication) | | streaming between the app, the |
| | | platform and then another app. |
| | | Includes encryption, jitter |
| | | buffering and adaptive bitrates |
| | | (for a variety of internet speeds) |
| SIP (Session | Call signaling and | Used to establish, modify, terminate |
| initiation Protocol) - | session control | calls - especially when integrating |
| | | with PSTN (public switched telephone |
| | | network) |
| TURN (traversal using | Media relay when direct | Relays media through a TURN server |
| relays around network | connection fails | if direct peer-to-peer connection |
| address translators) | | is not possible (firewalls etc.) |
| Media servers or plugin | Call control and media | Recording and possibly transcoding |
| libraries Opus/VP8/ | handling | Compresses decompresses and aids in |
| H.264 Codec | Encoding decoding audio | streams |
| | video | |
| Push notification | Incoming call alerts etc. | Wakes up the system app and notifies |
| services | | the user of incoming calls |
| REST | API endpoint method | AIlows the apps to interact with the |
| | | platform |
| Monitoring/ | Performance monitoring, | Interaction logging and system |
| logging stack | data collection, call | performance monitoring |
| | logging | |

Turning now to FIG. 32, representative AI agent flow where an AI agent uses the AI Agent Authority and Certificate Modules of the system as input for identity verification, AI agent behavior monitoring, and communications on a platform other than the system, is shown and described.
Scenario: A consumer electronics retailer is reaching out to a customer to confirm a technical appointment at one of their retail locations.
Initiation of conversation: The scheduling system indicates the need to confirm the appointment with the customer.
Prerequisites: The system platform has issued a system AI Agent Certificate to the consumer electronics retailer to use with the AI agent in question.
AI agent platform: The consumer electronics retailer is using a third-party platform with an AI agent. This third-party platform has ingested the AI Agent Certificate from the system and has processed (understood) the cert payload. The third party employs an auditing system for the AI agent conversation. This is the system that measures the AI agent and its Capabilities and Delegated Tasks against what the AI agent is saying/doing.
Outcome: The AI agent, the AI agent platform, and the consumer electronics retailer have used the system for its AI agent cert and verification service. However, all other functions such as AI agent behavior monitoring and the communications itself have been performed on a separate platform.

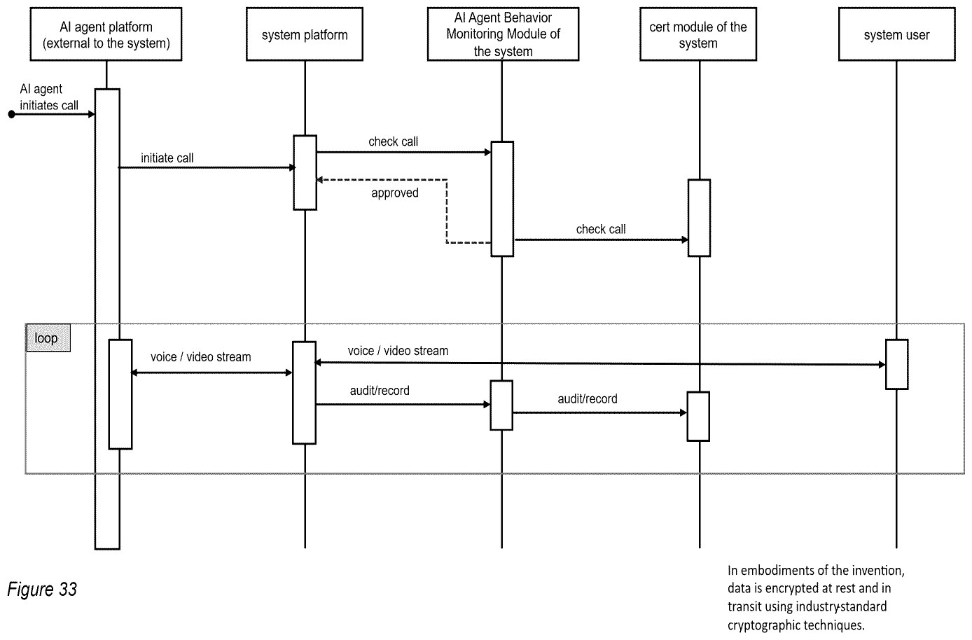

Turning now to FIG. 33, AI Agent Flow where AI Agent uses the system platform for behavior monitoring and for communication, is shown and described.
Scenario: a consumer electronics retailer is reaching out to a consumer to confirm an appointment at one of their retail locations.
Initiation of conversation: The scheduling system indicates the need to confirm the appointment with the customer.
Prerequisites: The system platform has issued an AI Agent Certificate to the consumer electronics retailer to use with the AI agent in question.
AI Agent Platform: The consumer electronics retailer is using a third-party platform with an AI agent. The third-party platform has ingested the AI Agent Certificate issued by the system and has processed (understood) the payload.
The voice call is made through the system. The consumer electronics retailer's third-party platform initiates the call by communicating to the system first with the cert and the call intent.
Then if the call initiation is approved/successful the voice call is made through the system and is monitored/audited on an ongoing basis by the system.

A representative AI agent flow may include:
Step 1—An AI agent platform would like to make a voice/video call to a particular user (a user of the system).
   The AI agent is associated with a system cert that has the following parameters (see Table 2 Exemplary Payload Data Elements for an AI Agent Cert for detailed list):
      AI Agent System Identifier-used by the system to identify the registered AI agent against the cert issued by the system.
      AI Agent Operating Environment—the technical environment in which the AI agent may operate.
      Approved AI Agent Geo-system user geographies where the AI agent is permitted to operate.
      System Cert Issue Date and System Cert Expire Date-confirming the cert is currently valid.
      Delegated Tasks—these are enumerated tasks the AI agent is allowed to perform when interacting with system users: e.g., initiate_call, route_call, schedule_appointment, collect_payment, send_email, send_text.
      Responsible Human and Responsible Organization IDs indicating the individual and organization who are putting their identities up as collateral along with the AI agent, against fraud occurring in the interaction.
      The cert, signed by the AI Agent Authority Module of the system.
   At the point of the AI agent initiating an action (e.g., initiate_call, send_email) the AI agent delegated tasks are checked against the action by the AI agent platform.
      If the stated action is consistent with the delegated tasks stated in the certificate, the AI agent is allowed to execute the act.
Step 2—During the conversation (AI agent to human) the communication system interacts with the AI Agent Behavior Monitoring Module of the system to ensure the AI agent is behaving in line with its delegated tasks and in line with human social norms.

### Messenger/Text/Chat Flow

Referring to FIG. 34, messenger/text/chat flows are similar to the aforementioned video/voice call flows. In both cases, a voice/video call and a text message, the following steps are followed:
   Initiator (AI or human) specifies the receiver
   The platform checks the following:
      Whether the receiver is a user on the system platform.
      The identity-as-collateral security preferences stipulated by the sender and receiver of the communication.
      Based on whether or not the receiver is a user on the system platform and both parties' identity-as-collateral preferences, the platform will proceed with one of the following actions.
         Allow the communication to proceed in the system platform
         Allow the communication to proceed outside of the system platform (via PSTN or SMS)
         Disallow the communication to proceed (either because of the sender's or receiver's identity-as-collateral settings or both).
   The platform checks are done in the following steps.
      The caller's system client mobile app makes an API call to the system platform, the system platform does the checks above and either
         returns an approval indication (true/false) and also a finer grained detail on the approval, i.e. the receiver has staked their identity or not

Step 1—An AI Agent platform would like to have a text conversation with a particular user (a user of the system).
The AI agent is associated with a system cert that has the following parameters (see Table 2 Exemplary Payload Data Elements for an AI Agent Cert for detailed list):
   AI Agent System Identifier—used by the system to identify the registered AI agent against the cert issued by the system.
   AI Agent Operating Environment—the technical environment in which the AI agent may operate.
   Approved AI Agent Geo—system user geographies where the AI agent is permitted to operate.
   System Cert Issue Date and System Cert Expire Date-confirming the cert is currently valid
   Delegated Tasks—these are enumerated tasks the AI agent is allowed to perform when interacting with system users: e.g., initiate_call, route_call, schedule_appointment, collect_payment, send_email, send_text.
   Responsible Human and Responsible Organization IDs indicating the individual and organization who are putting their identities up as collateral along with the AI agent, against fraud occurring in the interaction.
   The cert, signed by the AI Agent Authority Module of the system.
At this point of the AI agent initiating an action (e.g., send_text) the AI agent Delegated Tasks are checked against the action by the AI agent platform.
   If the stated action is consistent with the delegated tasks, in the certificate, the AI agent is allowed to execute the act.

Step 2—During the conversation (AI agent to human) communication system interacts with the AI Agent Behavior Monitoring Module of the system to ensure the AI agent is behaving in line with its Delegated Tasks and in line with human social norms.

### Conversation Identity Transfer Service

This service is responsible for tracking, auditing and facilitating a conversation between parties (note that a conversation could be any of voice, video, messenger, email or any other mechanism where multiple parties converse or interact).

### Functions of the Conversation Identity Transfer Service Include:

Handshaking between initiator and receiver.
   Allows system user to understand who has put their identity up as collateral.
   Allows system user to specify if call will be received.
   Allows system user to understand if the call is initiated by an AI agent.
   Allows system user to understand if call is being initiated by a human or AI agent affiliated with an organization.
The exchange of data occurs at the beginning of the call.
   Throughout the call, the identity of the initiator is being transmitted.
Token/identifier for the conversation is generated by this service.
Logging communication and creation of interaction tokens.
   Exemplary interactions: a call, a video connection, an email, a text exchange.
   Each interaction is stored along with an interaction token.
      Each participant is able to reference any and all events they've participated in using the UI provided by the medium of the interaction (mobile app, etc.)
      Each participant gets an interaction token that represents the event that is distinct from the other participant's interaction token. An underlying non-public identifier is generated to link the separate interaction token together within the Identity Collateral Vault of the system.
      This “indirection” mechanism allows each participant to have an identifier for the event that can be referenced by the participant without risking that other participants might hold the same identifier and thereby allow a third party to violate the privacy of a particular interaction by tying the participants together.
      The system platform is the only holder of the non-public identifier that links the interaction participants together. This identifier and associated personal data is not shared unless under subpoena due to suspected fraud in that interaction.

### Email and the System Platform.

In some embodiments of the invention, a system user unilaterally puts their identity up as collateral against fraud for an outbound email, using the system, in the form of a system client-side browser extension and server-side system services, in combination with the system user's existing email provider.

### Process:

A registered system user downloads and installs on the user's device a system client-side email extension for use in the user's browser environment.

The system user logs into the system and into their existing email provider using the abovementioned client-side extension in the user's browser environment.

The user may view a list of email exchanges (their inbox) using the client-side extension of their browser. For emails sent by a verified system user who unilaterally put their identity up as collateral for that email, the user sees a UI designation displayed (an identity-as-collateral icon) in their inbox indicating that the sender put their identity up as collateral for that specific email.

This gives the recipient user confidence that the email is unlikely to be fraudulent because, even though the email sender may be anonymous, the recipient knows that the sender's identity has been validated by the system, the sender's identity has been put up as collateral against fraud in the Identity Collateral Vault of the system for that specific email, and the email contents have not been tampered with during transit.

In particular embodiments, the system client-side extension is configured to parse the system identity mail-part “signed” by the sender, securely confirm with the system server that the sender is a valid system user, and that their identity has been put up as collateral in the Identity Collateral Vault of the system for that email message, and display the UI element (identity-as-collateral icon) indicating this in the recipient's inbox.

The email sender, as a system user, will have composed the email using the system client-side extension in the browser environment on their own device. The sender is logged into their system client-side extension as a system user and logged into their email provider as they compose the email in the client-side browser extension.

Before sending the email, the sender chooses whether to put their identity up as collateral for that email in the user interface on their device, displayed by the system client-side browser extension.

If the sender chooses to put their identity up as collateral for that email, the system client-side extension, in some embodiments using a multi-part/mixed MIME part (Multipurpose Internet Mail Extensions) as a discrete message component of the email: encrypts and attaches the user's system certificate as an indication that the email is from a valid system user, generates and attaches a signed checksum of the email to disallow tampering with the email contents in transit, messages the system server to store the sender's identity in the Identity Collateral Vault of the system, receives confirmation from the system server that the sender's identity has been stored in the Identity Collateral Vault, and then sends the email through the user's existing email service to the recipient.

In cases where the email recipient is not a system user, the recipient will not have the system client-side extension for their browser environment so they will be unable to decode the MIME extension of the email and will not know whether the email came from a valid system user who unilaterally put their identity up as collateral against the email being fraudulent.

Interaction insurance for users of the system.

The system supports the provision of users with interaction insurance coverage. The policy pays out, should the user be the victim of fraud in a covered interaction using the system and where the parties have put their identities up as collateral using the system.

Insurance companies provide the insurance products and underwrite the policies.

The underwriting process is embodied in an automated insurance module of the system.
In particular embodiments, during system on-boarding, users click on a set of terms and conditions in the user interface to allow the system to use a subset of their personal information for insurance underwriting. The user is approving that their information may be transmitted to insurance companies for the underwriting process. An exemplary set of data may include:
Name
Address
Duration at address
Previous addresses and duration at address
Age
Government IDs
Completeness score for identity information
Employer information
Salary

The system interfaces with the insurance providers via secure API into automated external underwriting systems. Data is transmitted to the external underwriting systems along with a token identifier the system has assigned to its user.
To purchase insurance, in some embodiments, the user might be redirected to the insurer's site to complete the transaction.
In some embodiments, multiple insurers offer a quote for the user to choose from

The external underwriting system returns the product code, coverage parameters, policy duration, policy pricing and the system user token identifier upon completion of the underwriting process to the insurance module of the system.

The system presents the interaction insurance offer to the system user on the application display and, if accepted, the system records this acceptance against the user's details in the data vault of the system. The system transmits the acceptance to the insurance provider along with the personal details and token required for the insurance provider to administer the policy.

The system collects the insurance premiums from the system user and transfers the appropriate share of those premiums to the insurance provider.

Periodically the system gathers user interaction data from its Identity Collateral Vault, anonymizes and aggregates this data to protect the privacy of its users, and transmits this securely to the insurance underwriting platform as input into product development and risk management processes at the insurance providers who provide interaction insurance to system users. Exemplary data elements, include:
Tenure of users
Geography of interaction participants
Interaction types/channels-voice, text/sms, video, email, tech support calls, social media; including whether the user was communicating with non-participating contacts.
Dates, seasons, time of day, duration of the interaction, number of parties involved.
Number and type of interactions that resulted in fraud (e.g. where subpoenas were issued)
Friends & Family calls vs. outside calls. Number of cross-border calls. Point to point statistics.

### Interaction Insurance for System Users—AI Agents.

Embodiments of the invention also offer interaction insurance to cover the behavior of AI agents against fraud or other damages. The underwriting process is similar to that of providing interaction insurance to a human. The insurance is issued to the Responsible Human and Responsible Organization registered with the system and included in the AI Agent Cert payload from the system. Additional data from the AI Agent Cert is used to support the underwriting process. Exemplary data elements include:
AI Agent Capabilities.
AI Agent Delegated Tasks.
Model Fingerprint.
AI Agent Risk Score.
Approve AI Agent Geography.
Verifying authority.
   Insurance providers require that the AI Agent behavior Monitoring Module be used in every interaction for an insured AI agent.

Handling subpoena requests by using multiple computing domains “Decrypt Service”.

Processing subpoenas and releasing the personal information of participants in an interaction where fraud is suspected, is handled by a separate computing domain and operating entity of the system referred to herein as Decrypt Service. This separation from the system computing domain and operating entity (Encrypt Service) which is used for the user onboarding, user services and user communications portion of the system, reduces the risk of profit driven decisions on the Decrypt Service part of the operation and reduces the threat of undue influence that a government may try to exert on the system operating entity (Encrypt Service) to release personal information without due process. In this embodiment of the invention, a single operating entity (Decrypt Service) focuses on the protection of system users' personal information and the deliberative process of responding to a subpoena by releasing data associated with a fraudulent interaction.

This flow occurs when a participant in an interaction suspects that fraud was perpetrated in that interaction and for the purposes of investigation and potential prosecution for fraud, the identities of the participants in the interaction (put up as collateral and stored by the system in an Identity Collateral Vault) need to be revealed.
1. Dispute initiator (system user) goes to their historic list of conversations in the system app or browser extension.
2. In the case that the disputed interaction is initiated by an organization, the organization uses its own internal process to review the interaction identifiers in the system app.
3. The dispute initiator selects the interaction to be disputed and shares the system interaction token ids, date and time stamps for that interaction or series of interactions as part of a complaint with their local law enforcement.
4. Should local law enforcement receive approval from a judge to subpoena the details of the interactions, the subpoena is presented to the system operating entity Decrypt Service. Upon review, the Decrypt Service releases those details to law enforcement for further investigation, possible prosecution, and pursuit of other remedies for the victim of the fraud.
5. The release process within Decrypt Service takes place with multiple separate user passwords and an audit log of the release steps and handover of the personal data to law enforcement within the separate computing domain that is Decrypt Service.
6. Decrypt Service releases the following information
   1. Date and time of the interaction(s)
   2. Communications channels in the interaction(s)
   3. Personal information, government identifiers, current verified residential address, duration at that address, past residential addresses of parties to the interaction.

Smart Contracts and the system platform technology are described with reference to Table 4.

Smart contracts are a known construct. The system allows for each party to put up their identities as collateral for a smart contract, enabling smart contracts to become more fully enforceable in a world of anonymity.

The system application provides a Smart Contract Module including a management and editing interface for a validated system user to access on their end-user device.

With the smart contract editing interface, the verified system user is prompted step-by-step through the creation of a smart contract, including configuring the contract parameters (e.g., contract parties, contract terms, milestones, enforcement rules, dispute resolution, and payment method).

In some embodiments, the system user may share the smart contract with other system verified users via each system user's phone number, email or other unique identifier. The system securely transmits the contract to each party for review and acceptance.

The system users then “sign” the contract by putting their identities up as collateral in the system. The system validates each user biometrically, stores each signatory's identity as collateral in the Identity Collateral Vault of the system along with a reference token for the specific smart contract, and then writes the smart contract and reference token to a block chain as an irrevocable and immutable record of the agreement.

The system smart contract management interface allows the verified system user to review the smart contract terms and contract status through a display on their end-user device.

TABLE 4
Smart Contract Module technology of the system

| Section | Component | Notes/what it is doing |
|---|---|---|
| Identity & | The verification | The system platform which |
| authorization | service of the | validates, manages user |
| | system | identity information staking |
| | | (e.g., government ID |
| | | validation or other proofing) |
| Identity | Token issuance | Converts verified identity data |
| tokenization | service | into a cryptographic token |
| | | (e.g., DID JWT) that represents |
| | | the user without exposing raw |
| | | personal data, similar to PCI |
| | | tokenization in credit cards |
| | Token validation | Allows other systems (like the |
| | service | smart contract) to verify a |
| | | token's authenticity, |
| | | validity and link to the |
| | | original identity |
| Smart contract | Blockchain | The decentralized execution |
| platform | network | environment for the smart |
| | | contract (e.g., proprietary |
| | | blockchain, Ethereum, Polygon, |
| | | Hyperledger) which supports |
| | | custom contract logic |
| | Smart contract | Code that defines the agreement |
| | logic | terms of the contract i.e. the |
| | | landscaping agreement includes |
| | | the contract participants' |
| | | identity tokens and defines the |
| | | dispute resolution mechanism |
| Contract | Contract | A backend and/or dApp UI that |
| lifecycle | deployment | takes agreement parameters, builds |
| | service | the smart contract, injects |
| | | identity tokens and deploys it to |
| | | the blockchain |
| | Contract state | Process for both parties to sign and |
| | update mechanism | update milestones (the state of the |
| | | contract - “work started”, |
| | | “completed” etc.) and are |
| | | blockchain transactions signed by |
| | | each party's identity (private key) |
| Security | Key management | Secure storage and handling of |
| | | users' private keys (for |
| | | identity token signing and |
| | | blockchain signing) |

### Technical Platform

It should be recognized that any of the following conventional technologies may be modified in accordance with the teachings herein, to provide a technical platform suitable to support various embodiments of the present invention:

TABLE 5
High Level Components

| Component | Exemplary Role |
|---|---|
| System App (Client) | Used by users to place or receive verified calls |
| | and manage identity info. |
| System Platform | Authenticates users, checks registration, |
| (Backend) | routes calls, and manages identity verification. |
| Carrier network | Fallback for unverified users; standard phone |
| | calls are placed here. |
| Email/SMS notifier | Sends onboarding invitations to non-system |
| | users. |

TABLE 6
Technology Stack

| Layer | Exemplary Technology |
|---|---|
| Client App | React Native/Swift/Kotlin |
| API Gateway | Kong/AWS API Gateway/NGINX |
| App Layer | Node.js/Python/Go/Java (REST APIs) |
| Data Store | PostgreSQL/DynamoDB/Firebase |
| Notifications | SendGrid/Twilio SMS/Firebase |
| Voice Integration | Twilio/WebRTC/SIP stack |
| Identity Provider | OAuth2, SAML, Verify.gov, etc. |

### Technology Components

Data Storage: AWS S3 w/region pinning, IPFS w/encryption.
Encryption: AES-GCM (DEK), RSA or ECC (KEK/PKI).
Identity & Key Mgmt: AWS KMS/HashiCorp Vault/Smart Contract.
Timed Unlock Logic: Ethereum Smart Contract (timelock logic), or cloud-based logic+audit.
Auditing & Integrity: Blockchain log (e.g. Ethereum, Hyperledger) or append-only DB (e.g. AWS QLDB).
Region-Specific Routing: GeoDNS or API Gateway with geo-IP routing.

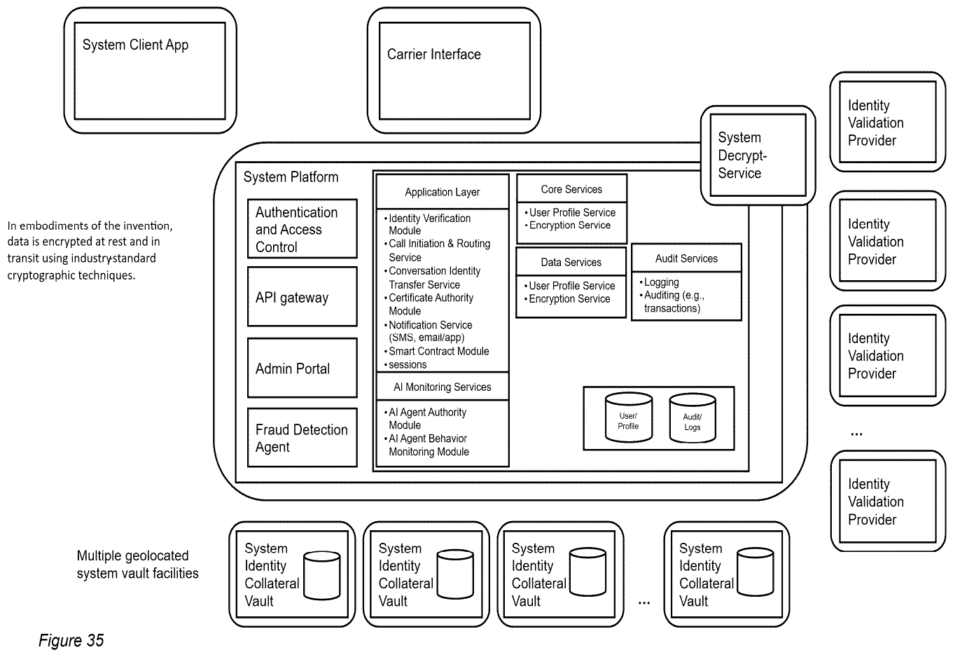

Turning now to FIG. 35, a representative Component Breakdown is shown and described.

Client App (iOS/Android/Web)
Initiates and receives calls.
Shows verified/unverified status.
Manages authentication (OAuth, token).
Displays identity metadata.

### Platform

### API Gateway (Entry Point)

Handles requests from mobile app, admin portal, and other external systems.
Provides rate-limiting, authentication handoff, API versioning, and basic analytics.
Examples: Kong, AWS API Gateway, Apigee.

### Authentication & Access Control Layer.

Supports:
   Username/password with encryption (e.g., Argon2 hashing).
   Federated login (Google, Apple, Microsoft, etc.).
   OAuth2/OpenID Connect/SAML.
Issues access+refresh tokens (JWT or opaque) and handles permissions/roles.
MFA (TOTP or WebAuthn) optionally enforced.

### Identity Verification Module.

Modular microservices support interfaces with different Identity Validation Providers per region.
Workflow orchestration handles retry/fallback logic (e.g., Onfido in the UK, Trulioo in Canada).
Full audit trail of identity verification process, including metadata and verification results.

### Identity Collateral Vault.

Microservice to manage storing/retrieving user identity info.
Data is end-to-end encrypted, with:
   A hybrid encryption model (data encrypted with symmetric key; key encrypted with asymmetric company/user keys).
   Delayed-access smart contract escrow model: needs user+company key after X days to decrypt.
Region-specific storage enforced (e.g., user's identity info stays in their data region).
Uses encryption at rest and in transit, plus field-level encryption for sensitive data.

### Call Initiation and Routing Service.

Abstraction layer over PSTN providers (e.g., Twilio, SignalWire, Plivo).
Handles:
   Outbound call origination and control.
   Voice recording.
   Call metadata logging.
Supports WebRTC integration for browser-based calling (admin portal?).

### Notification Engine.

Multi-channel notification microservice:
   Push (FCM/APNs), SMS, email, in-app.
Template-based, localized messages.
High-reliability via retry queues and dead-letter handling (e.g., Kafka+worker pool).

### Logging, Auditing, and Monitoring

Centralized structured logging (e.g., ELK stack or Datadog).
Tamper-resistant audit logs for:
   Identity verification events.
   Identity access.
   Data changes.
   Call initiation.
Alerting rules for anomalies or violations.

### Fraud Detection and ML Services

Uses real-time feature extraction from:
   Call behavior.
   Identity submission patterns.
   Device fingerprinting.
ML pipeline includes:
   Rule-based scoring.
   Anomaly detection.
   Risk prediction model.
Models retrained regularly with human-in-the-loop validation.

### Data Layer.

Relational DB (e.g., Postgres) for structured data.
Distributed object storage (e.g., S3/GCS/MinIO) for large identity documents.
Cache: Redis for session and hot data.
Message queue: Kafka, RabbitMQ for async flows.

### Geographically Distributed Deployment

HQ+multi-region API deployment for performance and latency.
Data residency controls enforce region-appropriate storage (e.g., AWS/GCP/Azure multi-region clusters).
Kubernetes orchestrates microservices across regions.
Can be audited and certified for local data sovereignty.

### Data Store.

A secure, distributed, and access-controlled data store for sensitive personal information, with regulatory and jurisdictional considerations.
Encryption & Privacy.
User and Company Access.
Geographic Storage Requirements.
Timed Unlocking (e.g., for subpoena compliance).

### Data Storage Architecture.

### Data Storage & Distribution.

Region-specific storage clusters (e.g., AWS Canada Central, EU West, etc.).
When a user registers, their data is pinned to a region based on residence.
Backed by distributed object stores (e.g., S3, GCP Storage, or IPFS+Pinning service if decentralized).

### Encryption Model

Data is encrypted client-side before upload:
   Using a symmetric key (Data Encryption Key, DEK).
   DEK is encrypted with an asymmetric scheme:
      One key derived from the user's password or device credential.
      Another key belongs to the company (for legal access).

### Access Control: Dual Key System (Smart Contract).

Similar to a 2-of-2 multisig:
   User decrypts DEK during normal use.
   Company can request unlock, but
      It requires: waiting period (e.g. 10 days).
      Governed by a policy engine or on-chain smart contract logic.

### Security Overview.

Data is only readable with the correct DEK (data encryption key), which is inaccessible without a valid key.
Even with full DB access, without the DEK nothing can be decrypted.
Geofencing ensures regulatory compliance (e.g., European user data never leaves Europe).
Auditable timed access supports legal unlock.

### Carrier Integration.

Optional fallback for unverified calls (via CPaaS or direct PSTN).
Third-party Identity Providers.
Optional integrations for higher-assurance ID (OAuth, bank ID, GovID, etc.).

### System API.

The system API enables 3rd party applications to utilize some of the features of the system platform including
Confirming that a user has put their identity up as collateral.
   By requesting a token that represents the user's identity which has been put up as collateral (though it contains no identity information).
      This token represents the identity of a particular user at a moment in time.
Allowing platforms to “record” or “log” interactions between identities that have been put up as collateral.
Allows platforms to check acceptance of an interaction between users.
   This is useful when a platform wishes to allow two users to communicate with each other.

### Exemplary API Endpoints:

ConfirmStakedIdentity
   Purpose
      Confirm that a user has put up their identity as collateral and get a system identity token to signify this.
      Similar to handling of credit card tokens used to protect sensitive data in a transaction.
   Inputs.
      email address, phone number.
   Output
      A token representing the user's identity that has been put up as collateral (though it contains no identity information). The token represents the identity of a particular user in a moment in time.
RecordInteraction.
   Purpose
      Allow a calling platform to record an event between staked parties.
         This act allows the event to be considered at a higher level of security because it itself is now backed by the system.
   Inputs
      The system Identity Token of the parties in the conversation.
      A representation of the “conversation event” that occurred.
         E.g., a text message, an email, a video call, a tweet. Note that for AI agent interactions where the AI Agent Behavior Monitoring Module of the system is being used, text, voice, and video of the interaction is recorded. The recording is saved upon completion of the interaction only if the AI agent breached its behavioral boundaries.
   Output
      A system interaction token representing the event.
CheckConnectionCapabilities
   Inputs.
      The system identity tokens of the parties that seek to connect for the purpose of a conversation (an enumeration).
Output
   A Boolean-true indicates the parties can be connected with their current system identity and settings.

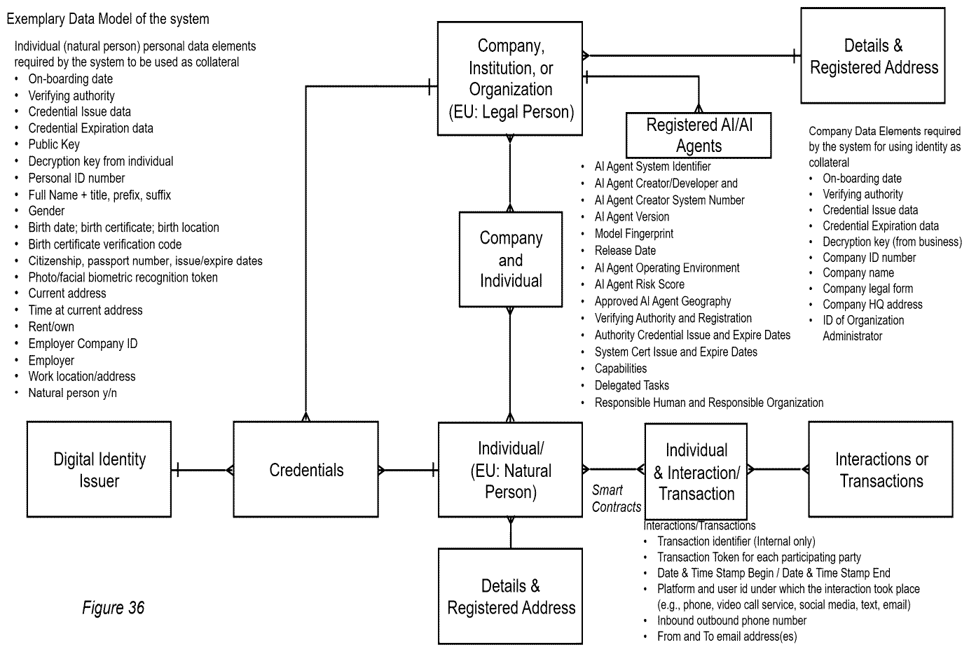

FIG. 36 is an exemplary data model for various embodiments of the present invention.

### Definitions

The following definitions are provided solely to promote clarity and consistency in the description of the disclosed embodiments and, unless expressly stated otherwise, are not intended to be limiting, nor to contradict or supersede any description set forth elsewhere in this specification or in the claims.
AI Agent Authority—the authority which signs the AI Agent Certificate used by the system. There is an AI Agent Authority Module which is a component of the system.
AI Agent Behavior Monitoring Module—This module of the system evaluates an AI agent's behavior during an interaction with another system user along multiple dimensions in real-time. Exemplary inputs include data from the AI Agent Certificate issued by the system. If the AI agent is overstepping its authority or misbehaving outside social norms, the system will warn the system user and provide an option for the system user to terminate the interaction.
AI Agent Capabilities—This is a list of the full breadth and depth of the actions that a particular AI agent is capable of executing. This list is an element of the AI Agent Certificate issued by the system and stored as machine-readable semantic tags to be processed by the system. Exemplary tags: e.g., write_code, onboard_cust, initiate_call, send_email, collect_payment, cancel_account.
AI Agent Certificate—Issued by the Certificate Authority of the system, the AI Agent Certificate is similar to an SSL certificate and has, encoded in it, all the information used to register an AI agent, as well as an indication that the certificate has been signed by an AI Agent Authority. This is a public key infrastructure (PKI) system for registering and authenticating AI agents with human accountability, permissions scoping, and identity. It is a trust framework for AI agents with a built-in chain of responsibility tied to identities that have been put up as collateral. It includes a link to a Responsible Human and a Responsible Organization. The AI Agent Certificate is also referred to in this document as an AI Agent Cert or “cert”.
AI Agent Risk Score—A score assigned by the system to an AI agent based on parameters from the AI Agent Certificate and the AI agent's monitored real-time behavior. In some embodiments, machine-readable inputs are provided by third-party AI agent risk services. The AI Agent Risk Score is used to determine when an AI Agent Certificate should be revoked.
AI Model Fingerprint—A token based on unique traits the AI agent model exhibits from its training and observed behavior. This AI Model Fingerprint is observed, generated, and refined by the system during an AI agent's interactions with system users.
AI Agent Creator/Developer—The organization which developed/programed the AI agent. This is different from the Responsible Human and Responsible Organization. For example the Responsible Organization may be a financial institution which is licensing the AI agent from the AI Agent Creator/Developer to run on the Responsible Organization's customer service platform.
AI Agent Delegated Tasks—A subset of an AI Agent's Capabilities which the AI agent is specifically permitted to execute when interacting with the system. This list is expressed in machine-readable configuration language and is stored in the AI Agent Certificate issued by the system.
AI Agent Operating Environment—This is the technical environment in which the AI agent may operate. It represents the boundaries of where the AI agent may operate. It is specified in the AI Agent Certificate issued by the system.
AI Agent Platform—This refers to the platform where an AI Agent operates. It is external to the system as an embodiment of the present invention.
Certificate Authority Module—This module of the system issues, signs, revokes and validates certificates (including AI Agent Certificates). It also manages root keys, rotation policies and can expose cert validation services via API.
Conversation Identity Transfer Service—This platform component of the system is responsible for tracking, auditing, and facilitating a conversation/interaction between parties (note that a conversation could be any of voice, video, messenger, email or any other mechanism where multiple parties converse or interact).
eID—An electronic identifier for proving the identity of persons, companies/organizations, and AIs. eID issuers are known as Identity Validation Providers. They are typically governments.
Identity as Collateral—Used to deter the use of digital anonymity to commit fraud in human-to-human, human-to-machine, and machine-to-machine interactions. To put one's identity up as collateral, each individual, who is party to a digital interaction (e.g., phone, text, video call, email, social media post), provides their verified digital identity and related personal information (e.g., name, address) to a trusted third-party which is using the system as an embodiment of the present invention, to facilitate the digital interaction and to securely store this personal information linked to the interaction. The personal information for each party to the interaction is retrieved, decrypted, and provided in response to a law enforcement subpoena should fraud have occurred in conjunction with that interaction. To stake one's identity is another term for putting one's identity up as collateral.
Identity as Collateral Icon/badge (IAC)—GUI representation indicating whether a party to an interaction has put their identity up as collateral.
Identity Collateral Period—This is the length of time after an interaction or series of related interactions have been concluded that the digital identity and personal information of those participating in the interaction are held securely by the trusted third party using the system as an embodiment of the present invention. This period is required in order to give enough time for potential fraudulent acts to come to light for investigation and prosecution. An example would be to hold identities as collateral for an 18-month identity collateral period following an interaction.
Identity Collateral Vault—The technology used by the system as an embodiment of the present invention to securely store encrypted digital identity and personal data that has been put up as collateral for an interaction/transaction.
Identity Validation Provider—A third-party which verifies the identity of a system user and in some cases, supplements the detailed system user data to be used for identity as collateral against fraud in an interaction. An Identity Validation Provider may specialize in the verification and credentialing of persons, organizations, or AI agents.
Interactions—These can be any number of human-to-human, human-to-machine, and machine-to-machine activities. Exemplary interactions are phone calls, text messages, video calls, emails, purchases, providing a service, data exchanges, social media posts, podcasts. They do not need to be one-to-one interactions. Interactions can also be one-to-many and even many-to-many.
Interaction Token—This is a unique alpha-numeric identifier associated with each interaction between verified users of the system. The token must be different for each party to the interaction. The token is visual proof to each party of an interaction that the system has captured the identity-as-collateral information for each party to that interaction. The token is also used as an identifier, should a user of the system contact the system provider for service/support regarding the system app and the particular interaction being referenced. It should be noted here that the system displays different tokens in system apps for each party to the interaction to protect their privacy and ensure that no one could use matching interaction tokens to maliciously connect individuals in an interaction. The system keeps a reference token which connects the individual interaction tokens to an interaction/transaction securely stored within the Interaction Vault of the system.
Interaction Vault—This is the technology used by the system as an embodiment of the present invention to securely log encrypted interaction/transaction information for individuals who have put up their identities as collateral against these interactions/transactions. It is a component system of the Identity Collateral Vault.
Responsible Human—this is the human being who is fully registered with the system and who is linked to a specific AI agent or agents. The Responsible Human has placed their identity up as collateral against the AI agent misbehaving or committing fraud in an interaction with another system user (human or AI agent). For an AI agent to receive a cert to interact with system users, there must be a registered Responsible Human.
Responsible Organization—This is the organization to which the Responsible Human and the Responsible Human's registered AI agent belong. A Responsible Organization is usually part of the registration of an AI agent. However, it is only required when the AI agent belongs to an organization. A Responsible Human is always required for the registration of an AI agent with the system.
Verifying Authority—This is an Identity Validation Provider that specifically authenticates an AI agent (e.g. a self-regulatory industry association, the European Commission, the system itself).

In light of the foregoing, embodiments of the present invention provide at least the following aspects that are believed to be advances which overcome drawbacks associated with the prior art.
Onboarding an AI and having that AI and its Responsible Human each put up their identities as collateral in an interaction.
The cert for the AI agent contains, among other items, the overall list of the AI Agent's capabilities so the system can understand the inherent risk of that AI Agent's potential misbehavior as well as the specific delegated tasks of the AI Agent for interacting with system users. This allows the AI agent's specific behavior in the system to be monitored.
The system conducts real-time monitoring of an AI agent's behavior and notifies the participants in an interaction when the AI agent's behavior deviates from its delegated tasks during the interaction. Automatic shut down of the interaction because the AI agent has violated its cert is a user option in the system.
Initiating an interaction between one or more humans and/or AI Agents where identities are being put up as collateral on any of the following communications channels: voice, text/SMS, email, video call, social media, tech support screen sharing.
Functions to handle manual or automatic steps to put one's identity up as collateral when a voice call, text session, video call, or tech support call is being initiated.
Icons and color coding are used in real time in the system app to indicate to each party that each party to an interaction has put their identity up as collateral during that interaction.
Real time assignment of tokens on the front end to each interaction participant as a point of reference. These tokens are different in order to protect the privacy of each interaction participant. However, on the backend, a single token is used to store information about the interaction across all the participants.
An individual can put up their identity as collateral unilaterally against fraud either in the context of social media, email, or in any other type of interaction.
Secure APIs with social media platforms for users' identities to be put up as collateral against fraud.
Secure API with customer support platforms for a tech support rep to put their identity up as collateral against fraud when interacting with their customers, especially during screen sharing sessions.
Setting up a smart contract/offer and acceptance of that smart contract offer in conjunction with both parties putting their identities up as collateral against fraud.
Separation of responsibilities, via separate computing domains between Encrypt Service domain and Decrypt Service domain to support the unique role each entity plays in the system.
   Encrypt Service computing domain.
      Responsible for the onboarding of users, encrypting and storing the user's personal data to support the process of putting their identities up as collateral.
      Offering interaction insurance policies.
      Enabling interactions between users.
      Recording details about interactions between users and assigning tokens to those interactions.
      Encrypt Service domain stores the user's personal information for the purpose of putting their identity up as collateral and administering the account.
      Only the system user can access and maintain their personal information in the account admin interface (bio metrics required to access view/update the data) in the Encrypt Service domain.
      Encrypt Service domain employees may only view a user's personal information for the purposes of helping with account maintenance and only if the user permits it.
   Decrypt Service domain.
      A separate entity from Encrypt Service domain with a separate computer domain.
      Decrypt Service domain stores keys for decrypting the personal data which is stored in Encrypt Service domain.
      Where Encrypt Service domain can only access a user's personal data with permission from the user, Decrypt Service domain employees can decrypt a user's personal data associated with an interaction without permission from a user if it is subpoenaed by law enforcement in support of a fraud investigation/prosecution.
AI Agent Behavior Monitoring Solution Module-using inputs from an AI Agent Certificate to ensure an AI Agent is behaving within its defined boundaries when interacting with humans and other AI Agents.
Insurance offer/underwriting for interactions based on the parties putting their identities up as collateral against fraud occurring in that interaction.

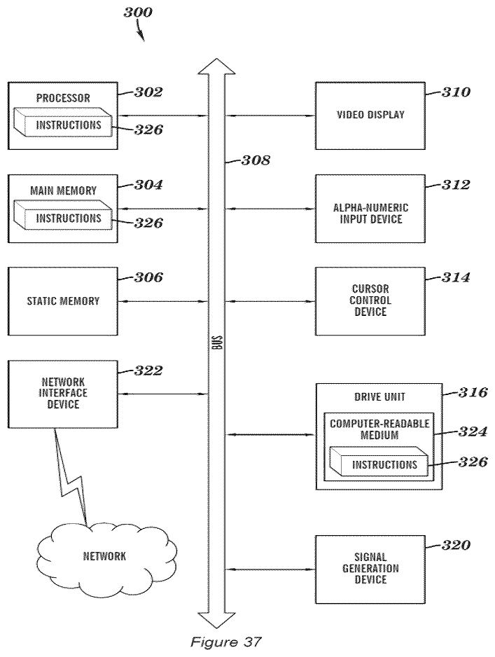

FIG. 37 shows a diagrammatic representation of a machine in the exemplary form of a computer system 300 within which a set of instructions, for causing the machine to perform any one of the methodologies discussed above, may be executed. In alternative embodiments, the machine may include a network router, a network switch, a network bridge, Personal Digital Assistant (PDA), a cellular telephone, a web appliance or any machine capable of executing a sequence of instructions that specify actions to be taken by that machine.

The computer system 300 includes a processor 302, a main memory 304 and a static memory 306, which communicate with each other via a bus 308. The computer system 300 may further include a video display unit 310 (e.g., a liquid crystal display (LCD), plasma, cathode ray tube (CRT), etc.). The computer system 300 may also include an alpha-numeric input device 312 (e.g., a keyboard or touchscreen), a cursor control device 314 (e.g., a mouse), a drive (e.g., disk, flash memory, etc.,) unit 316, a signal generation device 320 (e.g., a speaker) and a network interface device 322.

The drive unit 316 includes a computer-readable medium 324 on which is stored a set of instructions (i.e., software) 326 embodying any one, or all, of the methodologies described above. The software 326 is also shown to reside, completely or at least partially, within the main memory 304 and/or within the processor 302. The software 326 may further be transmitted or received via the network interface device 322. For the purposes of this specification, the term “computer-readable medium” shall be taken to include any medium that is capable of storing or encoding a sequence of instructions for execution by the computer and that cause the computer to perform any one of the methodologies of the present invention, and as further described hereinbelow.

Some portions of above description present the features of the present invention in terms of algorithms and symbolic representations of operations on information. These algorithmic descriptions and representations are the means used by those skilled in the data processing arts to most effectively convey the substance of their work to others skilled in the art. These operations, while described functionally or logically, are understood to be implemented by computer programs. Furthermore, it has also proven convenient at times, to refer to these arrangements of operations as modules or by functional names, without loss of generality. It should be noted that the process steps and instructions of the present invention could be embodied in software, firmware or hardware, and when embodied in software, could be downloaded to reside on and be operated from different platforms used by real time network operating systems. Moreover, the particular naming of the components, capitalization of terms, the attributes, data structures, or any other programming or structural aspect is not mandatory or significant, and the mechanisms that implement the invention or its features may have different names, formats, or protocols.

The present invention is well suited to a wide variety of computer network systems over numerous topologies. Within this field, the configuration and management of large networks comprise storage devices and computers that are communicatively coupled to dissimilar computers and storage devices over a network, such as the Internet.

Modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. It should be further understood that any of the features described with respect to one of the embodiments described herein may be similarly applied to any of the other embodiments described herein without departing from the scope of the present invention. As used in this document, “each” refers to each member of a set or each member of a subset of a set.

The present invention has been described in particular detail with respect to various possible embodiments, and those of skill in the art will appreciate that the invention may be practiced in other embodiments. First, the particular naming of the components, capitalization of terms, the attributes, data structures, or any other programming or structural aspect is not mandatory or significant, and the mechanisms that implement the invention or its features may have different names, formats, or protocols. Further, the system may be implemented via a combination of hardware and software, as described, or entirely in hardware elements. Also, the particular division of functionality between the various system components described herein is merely exemplary, and not mandatory; functions performed by a single system component may instead be performed by multiple components, and functions performed by multiple components may instead performed by a single component.

Moreover, unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices.

Embodiments of the present invention also relate to an apparatus for performing the operations herein. This apparatus may be specially constructed for the required purposes, or it may comprise a computer selectively activated or reconfigured by a computer program stored on a computer readable medium that can be accessed by the computer. Such a computer program may be stored in a tangible, non-transitory, computer readable storage medium, such as, but is not limited to, any type of disk including floppy disks, optical disks, CD-ROMs, magnetic-optical disks, read-only memories (ROMs), random access memories (RAMs), EPROMS, EEPROMs, magnetic or optical cards, application specific integrated circuits (ASICs), any other appropriate static, dynamic, or volatile memory or data storage devices, or other type of media suitable for storing electronic instructions, and each coupled to a computer system bus. Furthermore, the computers referred to in the specification may include a single processor or may be architectures employing multiple processor designs for increased computing capability.

In addition, the present invention is not described with reference to any particular programming language. It is appreciated that a variety of programming languages may be used to implement the teachings of the present invention as described herein, and any references to specific languages are provided for disclosure of enablement and best mode of the present invention.

Various systems may also be used with programs in accordance with the teachings herein, or it may prove convenient to construct more specialized apparatus to perform the required method steps. The required structure for a variety of these systems will be apparent to those of skill in the art, along with equivalent variations.

To aid the Patent Office and any readers of any patent issued on this application in interpreting the claims appended hereto, applicants wish to note that they do not intend any of the appended claims or claim elements to invoke 35 U.S.C. 112 (f) unless the words “means for” or “step for” are explicitly used in the particular claim.

Finally, it should be noted that the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention, which is set forth in the following claims. It should be further understood that any of the features described with respect to one of the embodiments described herein may be similarly applied to any of the other embodiments described herein without departing from the scope of the present invention.

Having thus described the invention, what is claimed is:

1. A computer-implemented method of operating a graphical user interface (GUI) on a client device to deter fraud during communications, the method comprising:
rendering, on a display, an incoming-communication panel comprising:
(i) an identity status region showing an identity-as-collateral (IAC) indicator for a remote party, and
(ii) one or more affordances including an identity request control and an answer control;
receiving, via a user input, an activation of the identity request control to request that the remote party stake an IAC credential for the communication;
in response to receiving a confirmation of the remote party's IAC credential from a remote service, updating the GUI by:
(a) toggling the IAC indicator from a first state indicating “not staked” to a second state indicating “staked,” and
(b) presenting a session token indicator associated with the communication;
generating, for the communication, a pair of privacy-preserving session tokens including:
(i) a first token to be displayed on the client device and
(ii) a second token, different from the first token, to be displayed on a device of the remote party,
wherein the first and second tokens are linked in a secure store to a non-public association token for the communication;
gating enablement of the answer control based on a staking policy, the policy specifying at least that the answer control is enabled upon the IAC indicator being in the second state or upon a user override input being received; and
during the communication, rendering the session token indicator within the GUI and, in response to a user selection of the session token indicator, presenting a token detail view including the first token while omitting the second token.

2. The method of claim 1, further comprising displaying a biometric verification affordance that, when activated, authenticates a local user and gates the answer control until authentication is successful.

3. The method of claim 1, wherein the GUI changes a color scheme or accent color, previously selected by the local user, when the IAC indicator transitions to the second state.

4. The method of claim 1, wherein updating the GUI comprises adding an annotation identifying the remote party as an artificial intelligence (AI) agent.

5. The method of claim 4, wherein the annotation identifying the remote party as an AI agent denotes that the AI agent is associated with a human or organization.

6. The method of claim 4, further comprising rendering an AI-monitoring status indicator and, when an AI-behavior monitor detects behavior outside delegated tasks, presenting a visual alert including at least one of: a framed token display, a termination recommendation banner, or a one-tap termination affordance.

7. The method of claim 1, wherein the GUI further comprises a messaging view including message bubbles, and rendering the IAC indicator adjacent at least one incoming message bubble, the IAC indicator toggling between the first and second states when the remote party stakes or withdraws the IAC credential.

8. The method of claim 7, further comprising rendering an age-category badge for the remote party when an age attribute is present in the IAC credential.

9. The method of claim 1, further comprising rendering a call-history view listing prior communications, each entry including a per-party IAC indicator and, upon selection, revealing the session token indicator for that entry.

10. The method of claim 1, further comprising rendering a contacts view listing contacts each with a corresponding IAC indicator and a per-contact policy control to require IAC staking prior to accepting communications from that contact.

11. The method of claim 1, further comprising, for email messages viewed within an email pane, rendering an IAC badge in at least one of: a message list item or a message reading view, the IAC badge indicating that an IAC credential was verified for a corresponding sender.

12. The method of claim 1, wherein the GUI renders an acceptance affordance that allows a user to proceed with the communication despite the IAC indicator being in the first state, and logs the acceptance as a policy override in association with the first token.

13. The method of claim 1, further comprising rendering a retention panel listing session tokens scheduled for purge and, upon user selection, showing a countdown until a retention period expiry.

14. The method of claim 13, further comprising, responsive to expiry of a predetermined retention period, removing a visual link to the first token from the GUI while maintaining an audit entry that the communication occurred.

15. The method of claim 1, wherein generating the pair of session tokens comprises deriving each token from a cryptographic seed associated with the communication and providing the derivation with a device-identifier unique to the respective party such that the tokens differ across parties for the same communication.

16. The method of claim 1, wherein the GUI renders a detail view showing that the IAC credential includes at least one of: a trusted-party-issued electronic identifier, a liveness-verified biometric binding, a Responsible Human Identifier or a Responsible Organization Identifier.

17. The method of claim 1, further comprising, prior to enabling the answer control, displaying a pending state in the IAC indicator while awaiting a staking response from the remote party and, after a timeout, presenting a prompt allowing the user to send a one-tap reminder request.

18. The method of claim 1, further comprising displaying, in a screen-sharing support view, a persistent IAC banner identifying a support representative or an AI agent as staked and presenting the session token indicator for the screen-sharing session.

19. The method of claim 1, wherein the GUI renders a settings view that allows configuration of staking policies by channel type, including voice calls, video calls, text messages, social posts, and emails.

20. The method of claim 1, further comprising, upon receiving a signed AI-agent capability certificate, annotating the IAC indicator with an AI badge associated with a delegated-tasks summary derived from the certificate.

21. The method of claim 20, wherein the AI badge is selectable by a user to display the delegated-tasks summary.

22. The method of claim 1, further comprising, responsive to receipt of an authenticated law-enforcement release instruction associated with the non-public association token, displaying within an administrative view a disclosure progress indicator and an audit trail entry for the communication.

23. A client device comprising one or more processors and a memory storing instructions that, when executed by the one or more processors, cause the client device to implement a GUI and perform operations comprising the method of claim 1.

24. A non-transitory computer-readable medium storing instructions that, when executed by one or more processors of a client device, cause the client device to present a GUI and perform operations comprising the method of claim 1.

25. The method of claim 1, wherein the GUI employs shape- or glyph-based encodings to distinguish human parties from AI agents in the IAC indicator, independently of color, to remain perceivable under reduced-motion or high-contrast accessibility settings.

26. The method of claim 1, wherein rendering the session token indicator comprises displaying a token for each party within a multi-party communication and, upon selection of a token, presenting per-party metadata without revealing other parties' tokens.

27. The method of claim 1, further comprising rendering, within a negotiations view, a smart-contract status strip indicating that counterparties have staked IAC credentials and that a contract milestone was acknowledged, each status entry being linked to a corresponding session token indicator.

28. A computer-implemented method of operating a networked anti-fraud platform, the method comprising: (a) storing, in an encrypted identity vault, verified identity records for registered parties, each record encrypted with a data-encryption key (DEK) whose DEK is itself encrypted under a key-encryption key maintained in a hardware key manager; (b) upon initiation of a communication between two or more registered parties, deriving per-party distinct session tokens from a shared seed and a device-specific identifier and linking the per-party distinct session tokens to a non-public association token stored in the identity vault; (c) enforcing a staking policy that requires each party to provide an identity-as-collateral credential prior to enabling a transport session; (d) writing an append-only audit log entry referencing the non-public association token and scheduling purge at expiry of a retention period; and (e) responsive to an authenticated law-enforcement release instruction referencing the non-public association token, validating dual authorizations from separate computing domains and decrypting and releasing only identity records bound to the referenced communication.

29. The method of claim 28, wherein enabling the transport session is denied until all parties present a credential signed by a trusted certificate authority.

30. The method of claim 28, wherein deriving the per-party distinct session tokens comprises inputting at least a platform-generated seed, a per-device identifier, and a channel-type identifier into a key-derivation function.

31. The method of claim 28, further comprising writing the audit log to a tamper-evident append-only store and maintaining a cryptographic hash chain across log entries.

32. The method of claim 28, wherein the encrypted identity vault and decryption authority are administered by distinct entities and a release requires time-locked dual authorization.

33. The method of claim 29, further comprising storing capability certificates for artificial-intelligence agents that enumerate a universe of capabilities and a delegated-tasks subset and binding each certificate to a Responsible Human.

34. The method of claim 28, further comprising exposing, to each party, only that party's distinct token via an application programming interface while preventing retrieval of any other party's token for the same communication.

35. The method of claim 28, further comprising embedding a staking receipt into channel-specific metadata for email, messaging, and voice and/or video signaling.

36. The method of claim 28, wherein encrypted records are stored in a geofenced region according to a domicile attribute of the party's electronic identifier.

37. A computer-implemented method for authorizing and monitoring artificial-intelligence (AI) agents, the method comprising: (a) issuing, by an AI-agent certificate authority, a certificate to an AI agent, the certificate including an agent identifier, a model fingerprint, a universe of capabilities, a delegated tasks subset, a Responsible Human Identifier, Responsible Organization Identifier, and a revocation status; (b) authenticating, by a verifier gateway, the certificate upon initiation of an interaction and publishing staking status to subscribed client devices; (c) monitoring, in real time, content generated by the AI agent including one or more of text, audio, or video, extracting features, and evaluating whether the content exceeds the delegated tasks; (d) responsive to detecting out-of-scope behavior, signaling client devices to render a conspicuous alert and providing a one-tap termination control; and (e) revoking the certificate and preventing further staking by the AI agent until remediation.

38. The method of claim 37, wherein responsive to detecting out-of-scope behavior, recording AI agent interactions to retain tamper-evident records of the out-of-scope behavior.

39. The method of claim 37, further comprising computing a risk score for the AI agent based on fused text, acoustic, and visual features and persisting the score in an audit log.

40. The method of claim 37, wherein the verifier gateway signals client devices when a requested capability associated with the interaction channel is not included in the delegated-tasks subset.

41. The method of claim 37, further comprising generating an explanation identifying a violated rule or delegated-task boundary and logging the explanation with a reference to the non-public association token.
